(19) United States
(12) Patent Application Publication
(10) Pub. No.: US 2018/0140965 A1
(43) Pub. Date: May 24, 2018

(54) PRODUCTION SYSTEM

(71) Applicants: Shale Flora, Newberg, OR (US); Dan Shelton, Eugene, OR (US)

(72) Inventors: Shale Flora, Newberg, OR (US); Dan Shelton, Eugene, OR (US)

(21) Appl. No.: 15/359,509

(22) Filed: Nov. 22, 2016

(51) Int. Cl. B01D 3/14; B01D 1/06; B01D 3/30; B01D 5/00; B01D 3/10; C11B 3/12

(52) U.S. Cl. CPC B01D 3/148; B01D 1/06; C11B 3/12; B01D 5/0063; B01D 3/106; B01D 3/30

(57) ABSTRACT

Methods and systems are provided for processing cannabinoids and related compounds using a production system comprising an evaporator connected to a distillation unit and condenser column. The product may be collected from the condenser column by a collection system comprising one or more collection tanks. Subsequently, the product may be manually or automatically conveyed from the collection system to storage vessels operating under atmospheric conditions.

### FIELD

The present description relates generally to methods and systems for processing cannabis and hemp plant material into cannabinoids and related compounds using evaporation and distillation processes.

### BACKGROUND/SUMMARY

Cannabis and hemp can be processed to yield viscous oils that are highly enriched in cannabinoids. Examples of cannabinoids include tetrahydrocannabinol (THC), cannabidiol (CBD) and cannabinol (CBN). Raw cannabis or hemp can be processed into an enriched oil using solvent evaporation or distillation. During processing, the cannabis or hemp plant material is washed with an organic solvent such as ethanol, isopropanol, or hexane to extract cannabinoids, wax, lipids, chlorophyll and terpenes which dissolve in the solvent. The plant material is removed, and subsequently the solvent is evaporated or distilled in a still or dish. Residual material left in the bottom of the still or dish is a viscous oil, highly enriched in compounds stripped from the cannabis or hemp plant material. The extracted oil may be further processed using cannabinoid distillation to produce a refined cannabinoid product. During cannabinoid distillation, a vacuum is applied to the distillation still (typically an absolute pressure ranging from 0.0001 mbar to 2 mbar), and the distillation still is heated up to a temperature between 100 C and 350 C. The compounds present in the extracted base oil can be separated out, and a refined, distilled oil that is highly enriched in THC or CBD or any other compound of interest may be obtained.

An example process and apparatus for extracting cannabinoids from natural materials is disclosed by Whittle in U.S. Pat. No. 9,034,395 B2. Therein, the process comprises heating the natural material with a hot gas in a rotary evaporator to vaporize constituent compounds. Subsequently, the vapor produced in the evaporator is passed through a condenser with a fractional column to separate a cannabinoid rich extract into different fractions. The extraction process may be operated continuously to produce cannabinoids at a large commercial scale.

However, in the example apparatus disclosed above, the evaporator may have a small production capacity, and may be difficult to clean after the cannabinoid product is extracted. Also, the rotary evaporator operates continuously, and may be difficult to customize for batch operations. Further, some continuously operated evaporators may only produce a single product fraction and a single bottom fraction. In some evaporation systems, the evaporators may be comprised of brittle materials such as glass which may break easily, increasing replacement costs.

The inventors herein have recognized the various issues discussed above, and developed a production system to at least partially address them. In one example, the production system may comprise: an evaporator connected to a distillation apparatus, condenser column, and collection system that permits batch or fed-batch modes of operation.

For example, the production system may be configured with the evaporator connected to the distillation column having a dephlegmator unit, and the column may be connected to the condenser. During operation, a product may be vaporized from feed material inside the evaporator and flowed through the distillation column, where the product vapor is fractionally separated into different product compounds. Subsequently, the product compounds are flowed from the distillation column to the condenser unit, where the compounds are cooled down before being conveyed to a collection system. In this way, the production system may allow multiple products to be produced from a single feed batch to improve production efficiency.

The approach described here may confer several advantages. For example, the evaporator may have a large production capacity, and may be operated in a batch mode to meet production needs while minimizing operating costs. Also, the evaporator may be designed to produce different product fractions from a single feedstock mixture, increasing production efficiency and minimizing production costs. Furthermore, the evaporator may be comprised of durable materials, allowing the production process to be conducted under varying operating conditions with minimal evaporator wear. In addition, the evaporator system may be cleaned easily, increasing product quality and system lifespan. The evaporator unit disclosed herein may be configured to perform both solvent evaporation and cannabinoid distillation. In this way, the evaporator system provides a simplified and efficient process of producing cannabinoid products from naturally occurring materials.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic depiction of an example production system for preparing cannabinoids and related compounds.

FIGS. 2A-2C show a schematic depiction of example evaporation vessels used for preparing cannabinoids and related compounds.

FIGS. 3A-3E show a schematic depiction of example distillation apparatus used in a preparation process of cannabinoids and related compounds.

FIGS. 4A-4D show a schematic depiction of example condenser systems used in the preparation process.

FIGS. 5A-5E show a schematic depiction of example product collection systems used in the preparation process of cannabinoids and related compounds.

FIG. 6 shows a schematic depiction of an example control system used for controlling a preparation process of the cannabinoids and related compounds.

FIG. 7 shows an example flowchart for the preparation process for cannabinoids and related compounds.

FIG. 8 shows an example graphical output of system variables used during preparation of cannabinoids and related compounds.

FIG. 9 shows an example graphical output of set point deviations and automated system corrections during preparation of cannabinoids and related compounds.

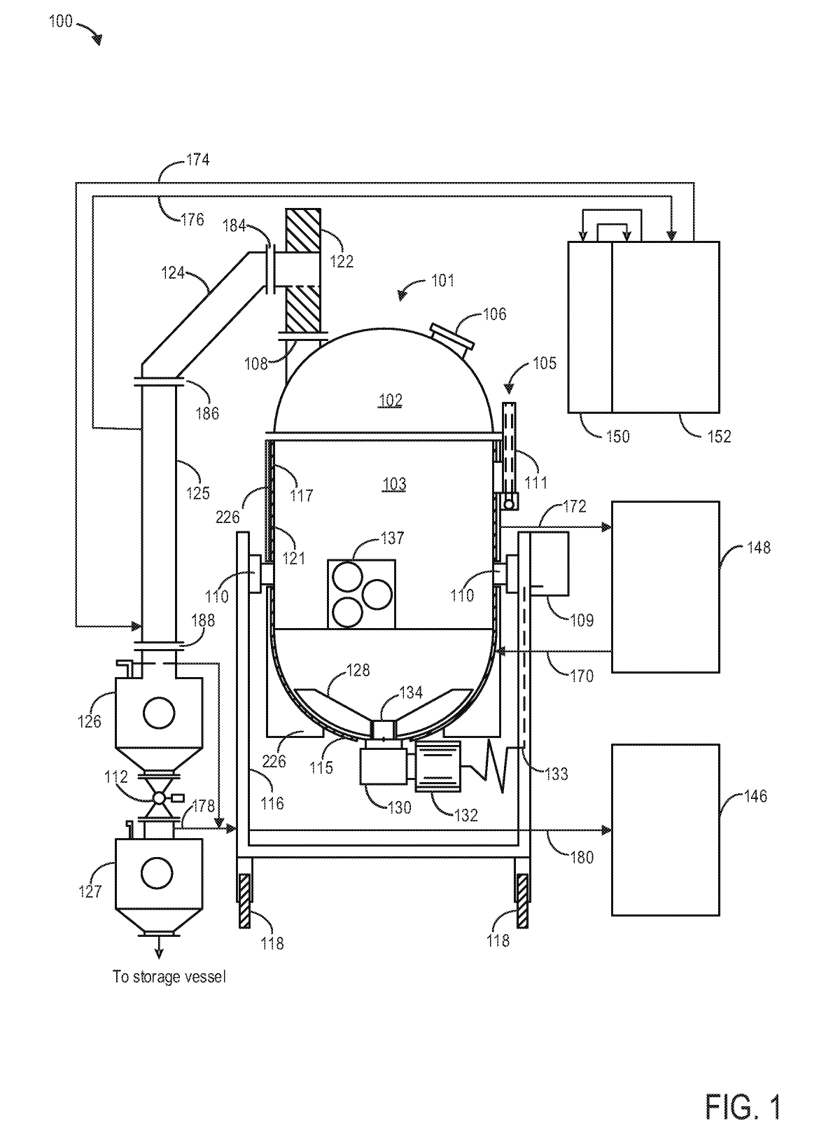

FIGS. 1-6 are shown approximately to scale, although other relative dimensions may be used, if desired.

### DETAILED DESCRIPTION

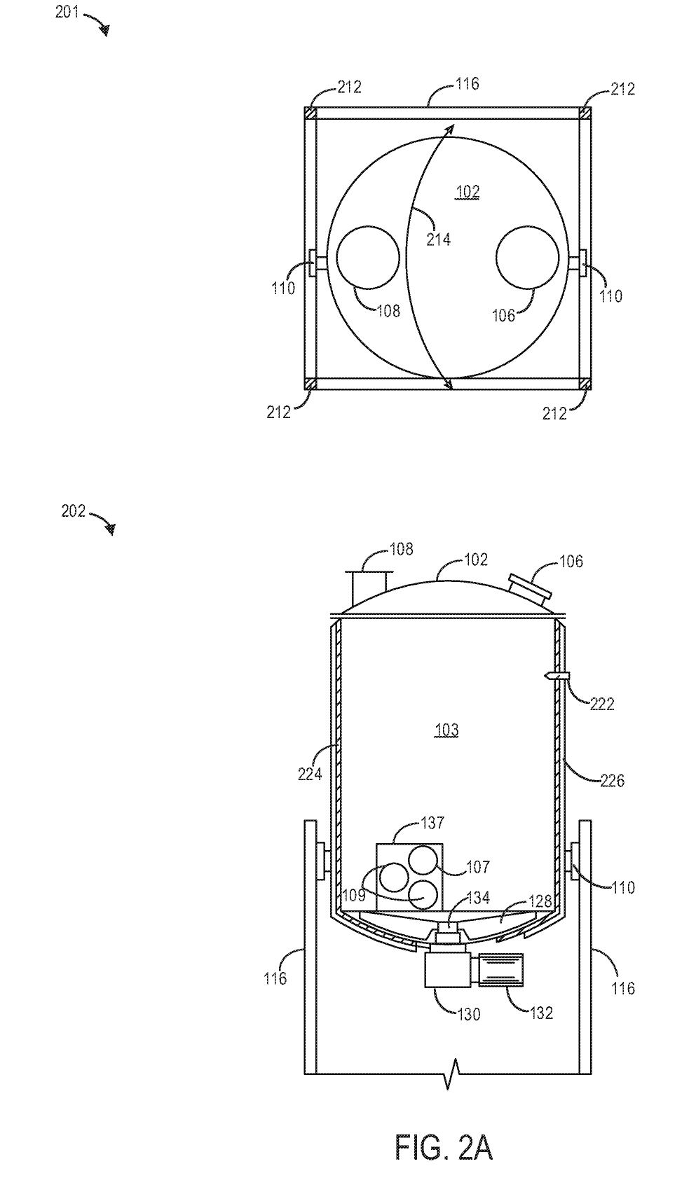

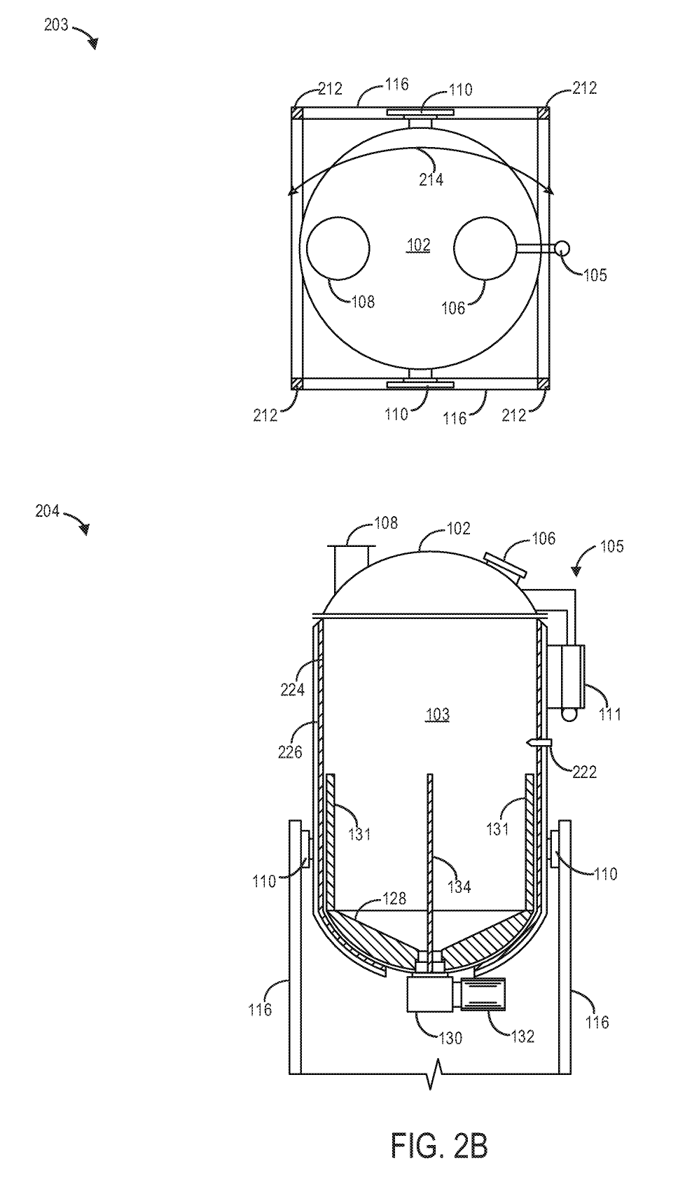

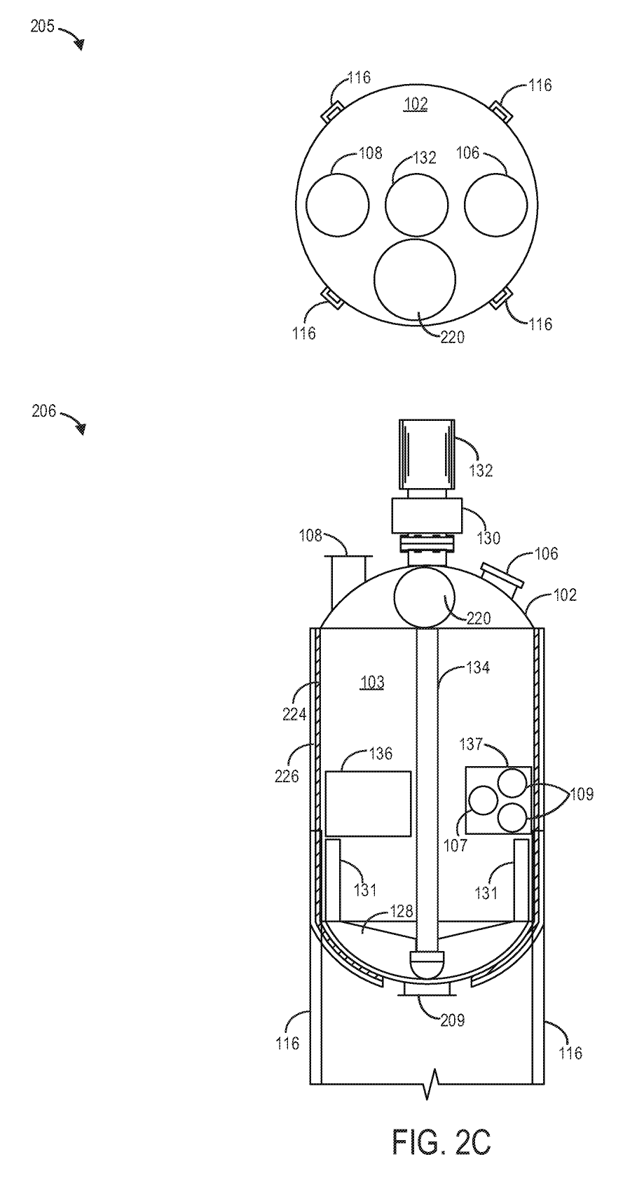

The following description relates to systems and methods for preparing terpenes, cannabinoids and related compounds from cannabis or hemp materials using an evaporation and distillation processes. FIG. 1 shows a schematic depiction of an example production system for preparing cannabinoids and related compounds. The production system comprises an evaporator vessel, a distillation column, a dephlegmator attached to a top portion of the evaporator vessel, a cylindrical tube that connects the dephlegmator to a condenser unit, and a collection system. FIGS. 2A-2C show a schematic depiction of a first, second and third example configurations of the evaporation vessel used for distilling cannabinoids and related compounds. Each of the first and second example vessel configuration depicts the evaporation vessel with a top removable cover and a bottom portion. The third example vessel configuration includes a top and side manway, and permanent top cover. As an example, each evaporation vessel may be externally mounted to a rigid light frame, which allows the vessel to be securely attached to a fixed platform, casters, or the ground surface.

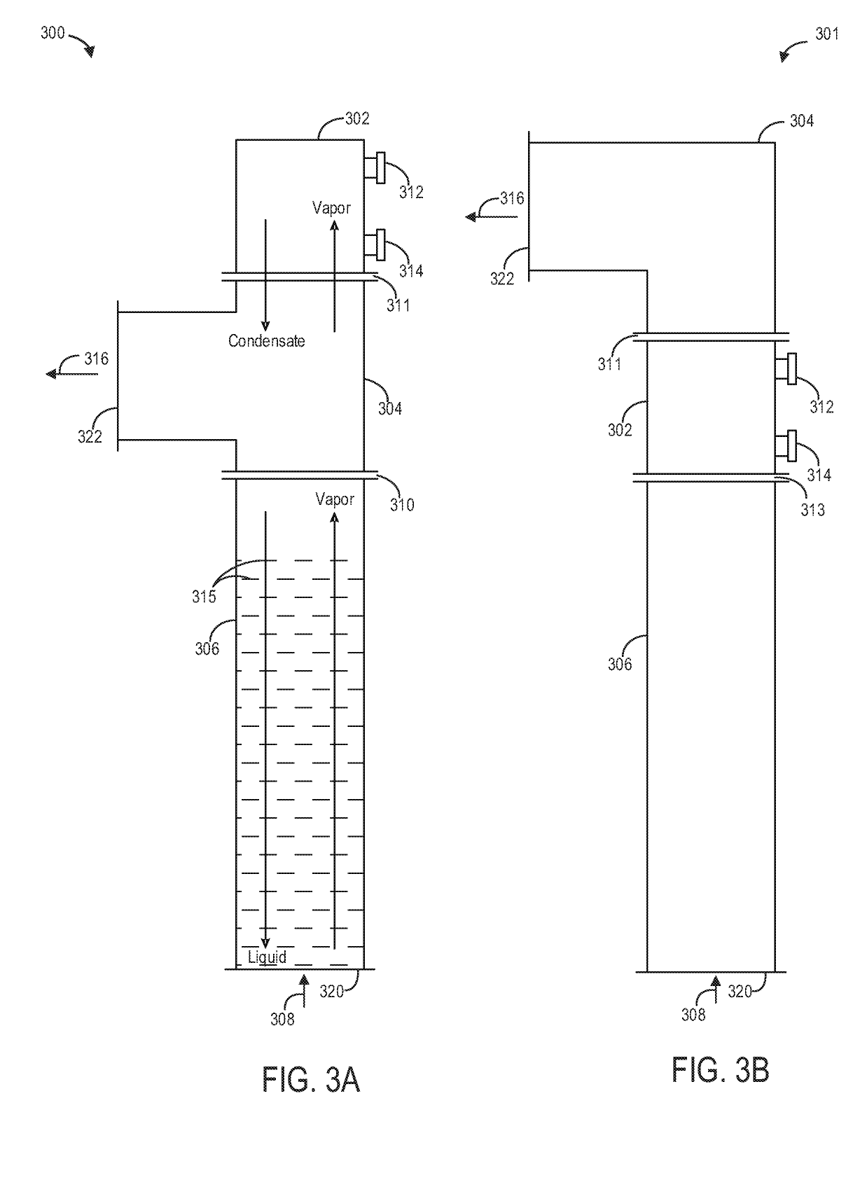

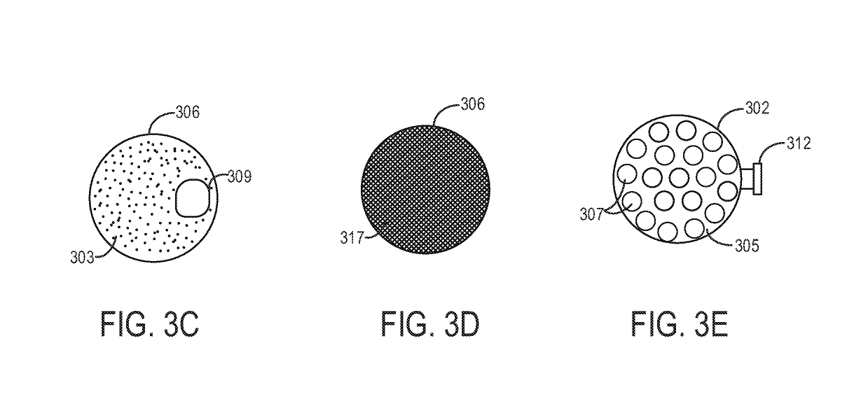

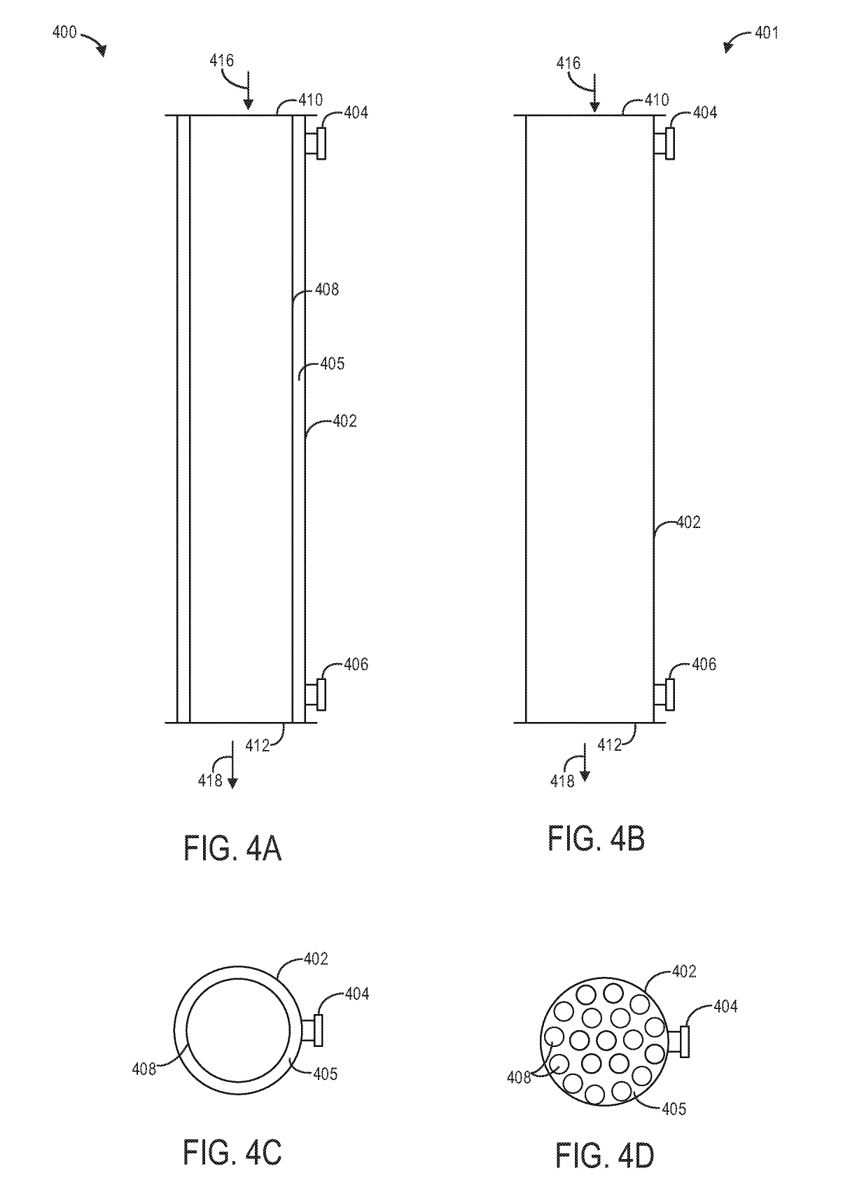

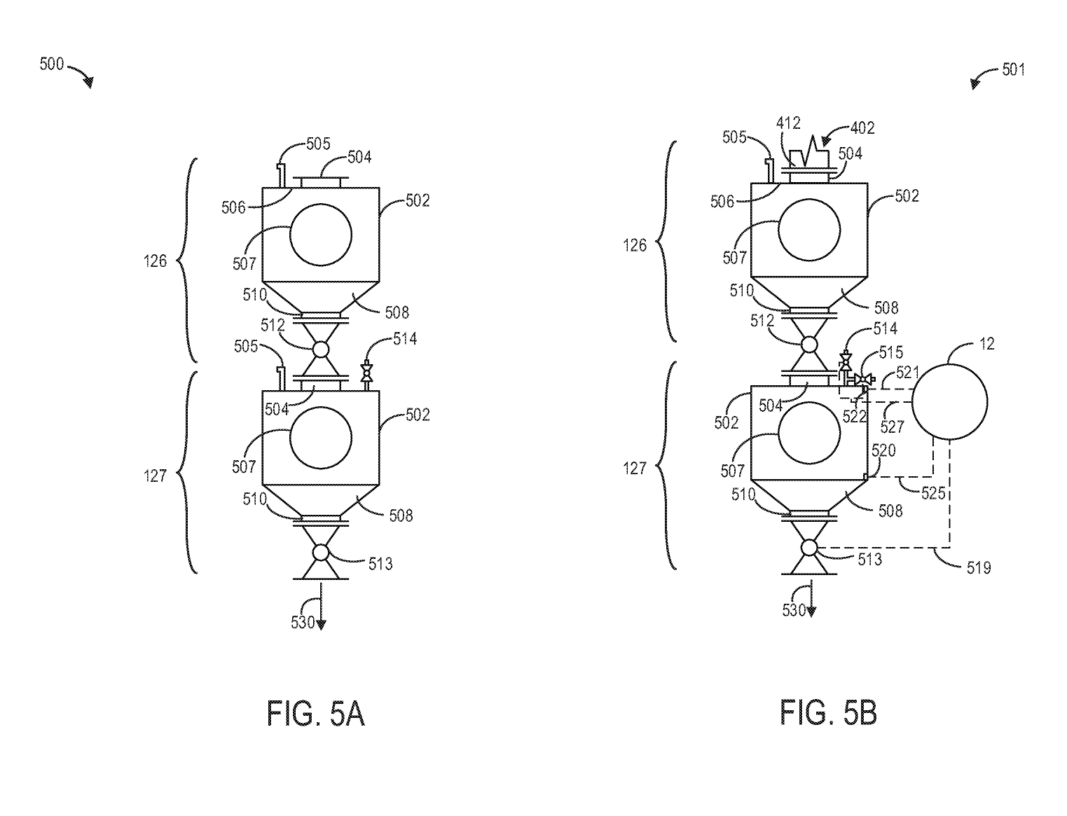

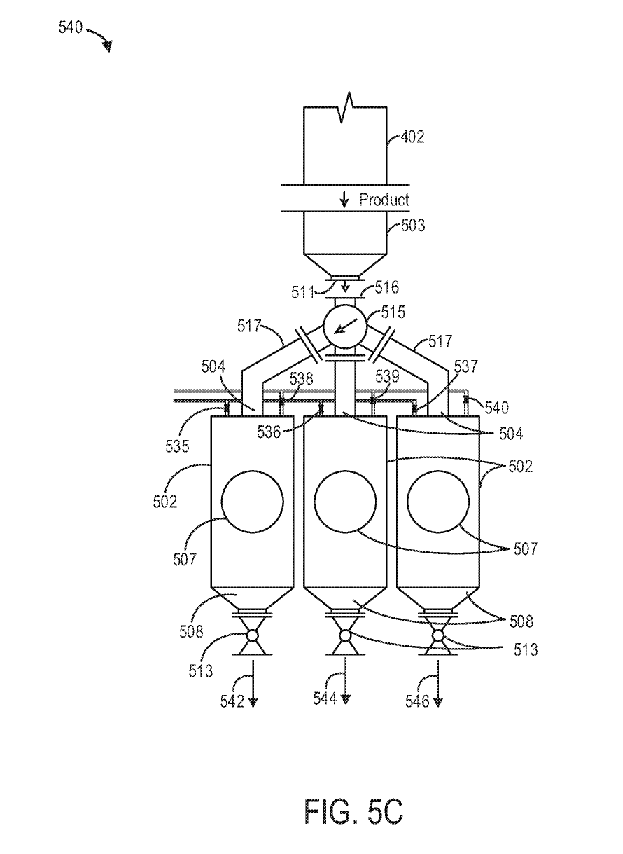

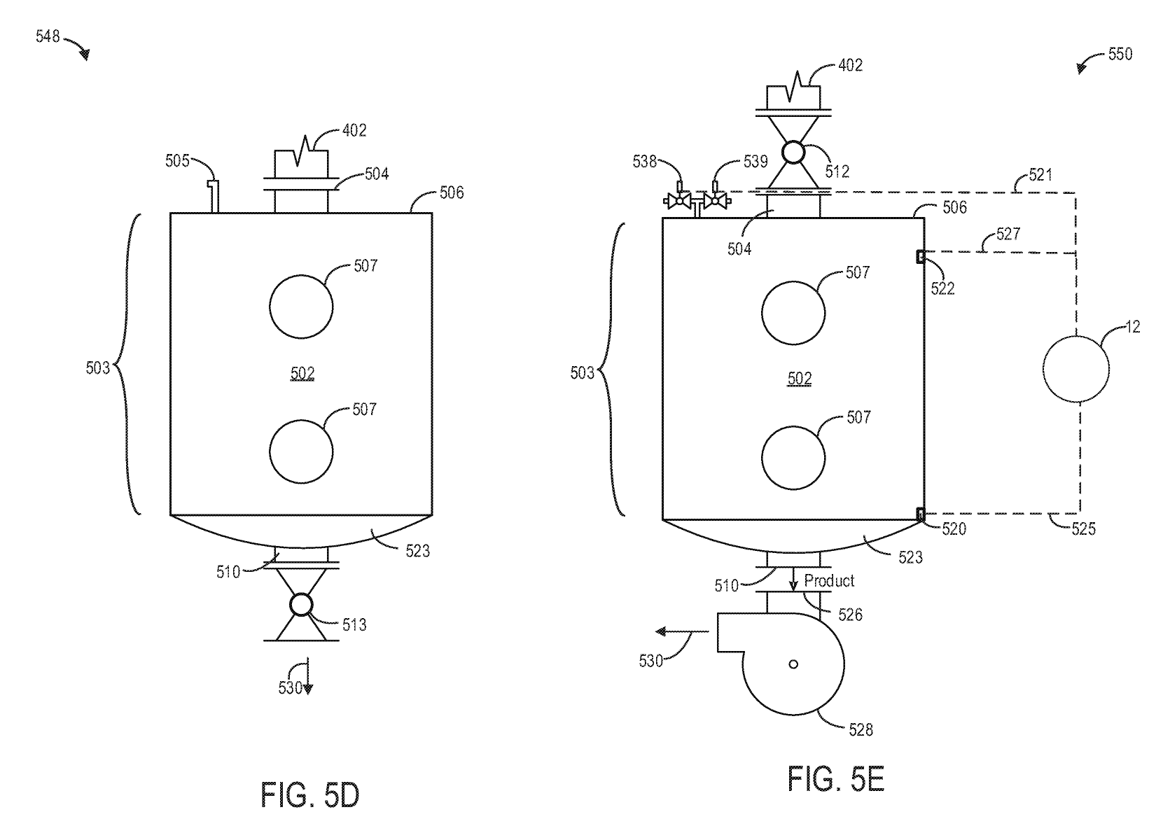

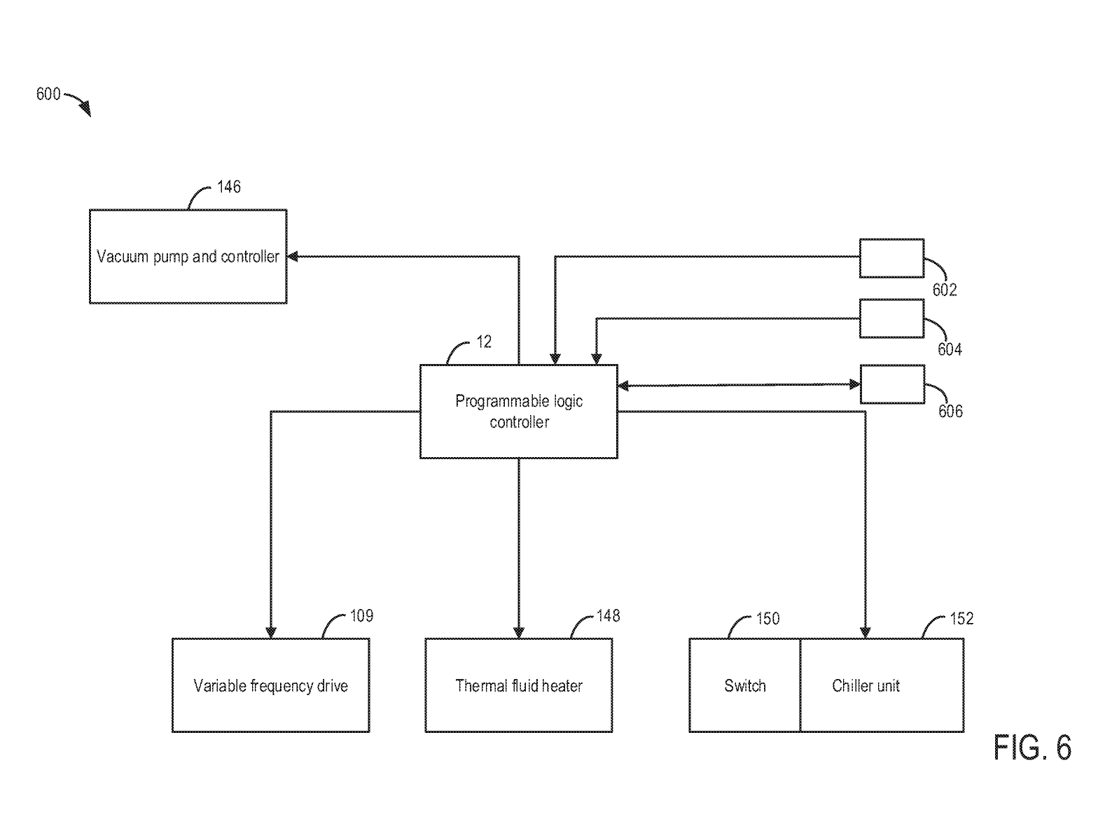

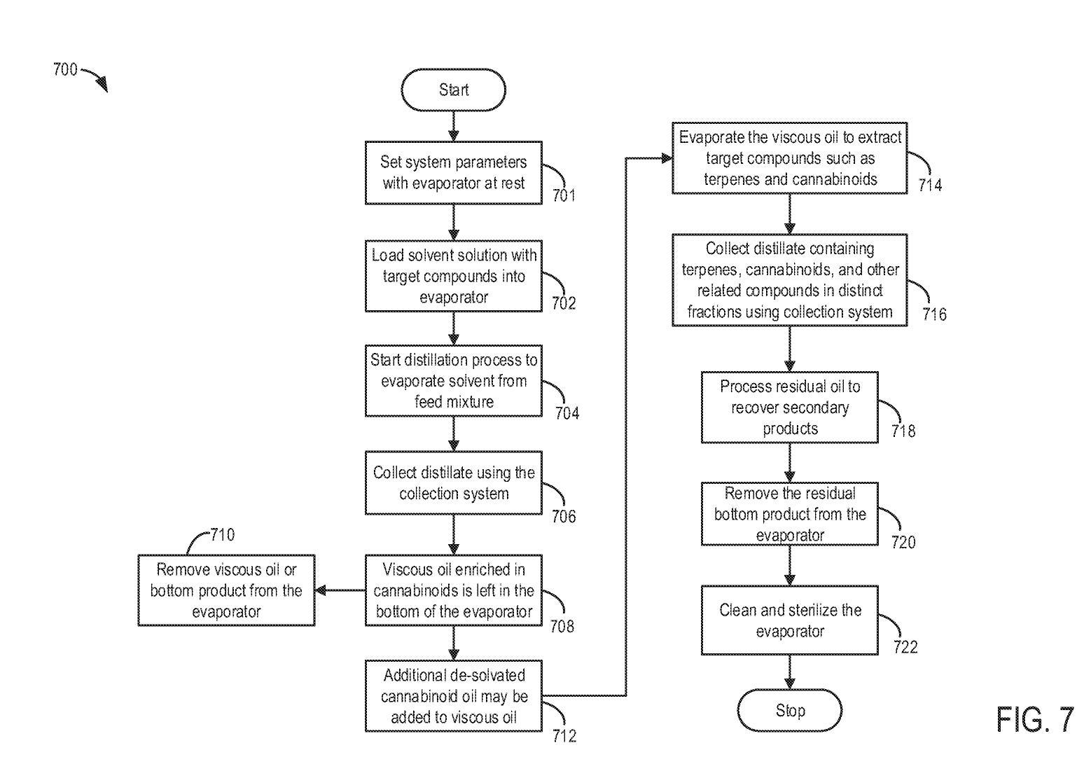

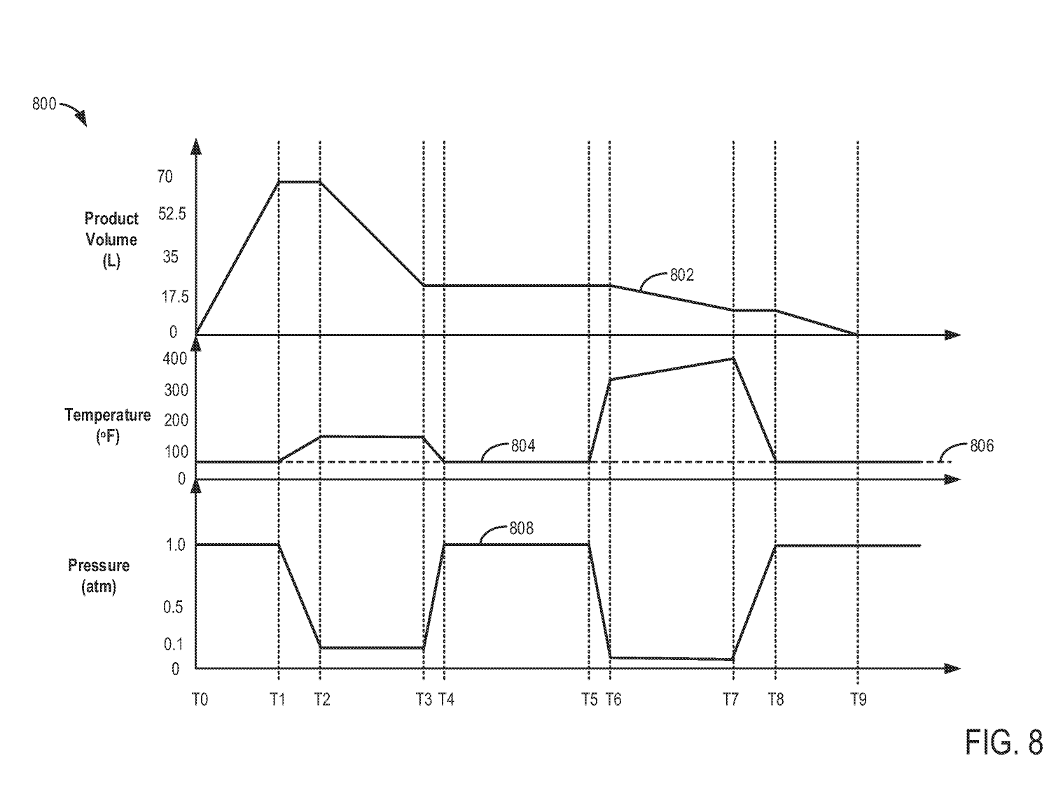

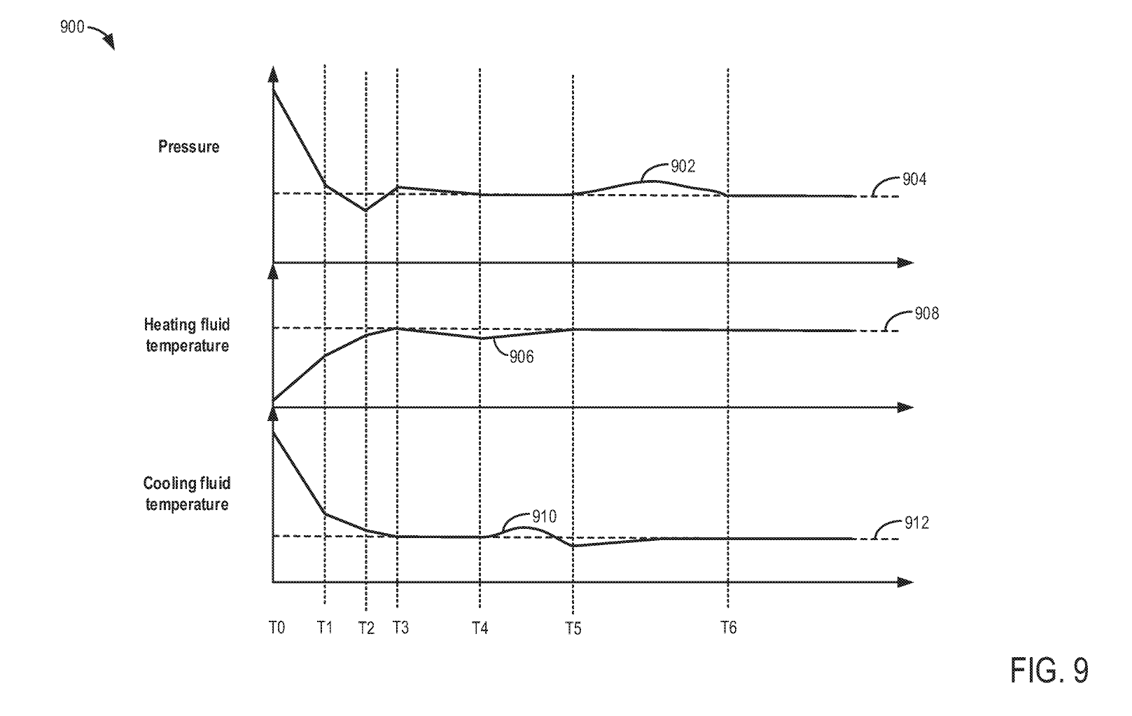

FIGS. 3A-3B, show a first and second embodiment of the distillation apparatus for processing cannabinoids and related compounds. Each embodiment of the distillation apparatus is comprised of a dephlegmator, transition portion, and distillation column. The dephlegmator has an inlet and outlet to allow for circulation of a coolant fluid through the distillation apparatus in such a manner that the coolant fluid does not come in contact with process fluid. Each distillation column is constructed with one or more distillation plates, as is shown in FIG. 3C or packed with a suitable material as shown in FIG. 3D. A plurality of cylindrical tubes may be mounted inside the dephlegmator as shown in FIG. 3E to allow for greater heat exchange area. A first and second embodiment of the condenser system is shown in FIGS. 4A-4B, respectively. Alternative views of the first and second embodiment of the condenser system are shown in FIGS. 4C-4D, respectively. Each embodiment of the condenser comprises a condenser shell with an inlet and outlet, to allow circulation of cooling fluid in the condenser. The inner region of the condenser column may contain one or more cylindrical tubes to cool or condense the distillate or product. FIGS. 5A-5E, show example embodiments of the collection system for collecting solvents, or cannabinoids and related compounds. The collection system may include a ball valve for manual operation. Alternatively, the collection system may include a check valve, automatically actuated ball or solenoid valve, and level sensors connected to a programmable logic controller (PLC) that allows the system to be automatically operated. FIG. 6 shows an example control system used for controlling the production system. The control system may comprise the programmable logic controller that sends instructions from a vacuum pump, variable frequency drive, thermal fluid heater, and switch-chiller unit. The PLC also receives signals from the user module, and from pressure sensors and temperature sensors, allowing pressure and temperature inside the evaporator to be actively controlled during the production process as disclosed at FIG. 7. The PLC may also send information and prompts to the user module, to assist the user in correct operation of the system. An example graphical output of system parameters used during production of cannabinoids and related compounds is shown in FIG. 8. The PLC continuously monitors and corrects system variables during operation, as is shown in FIG. 9.

FIGS. 1-5E show example configurations with relative positioning of the various components of the distillation apparatus, evaporation and collection systems used for preparing the cannabinoid product. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. In other examples, elements shown overlapping one another may be referred to as overlapping elements or overlapping one another. Further still, an element shown within another element or shown outside of another element may be referred as such, in one example.

Turning to FIG. 1, a schematic depiction of an example production system 100 for concentrating and refining cannabinoid compounds from a cannabinoid containing solution or feedstock is shown. As shown, the production system comprises an evaporation vessel 101, dephlegmator 122 attached to a top portion of the distillation apparatus, a transition portion 124 that connects the distillation apparatus to a condenser unit 125, and collection systems 126 and 127. The distillation apparatus may comprise a combination of the dephlegmator, distillation column and transition portion, for example.

As shown, the evaporation vessel comprises a top most removable cover 102 and a bottom vertical cylindrical portion 103 that may be fixed. For example, the top most removable cover may be securely fastened to a top portion of the vertical cylindrical section of the evaporator during production. The removable cover may be opened using an opening arm 105 attached to a side portion of the cover. As an example, the opening arm 105 may have a downward extending portion 111 that may be held by an operator when opening the removable cover from the evaporator. A slight glass 106 mounted on the top removable cover, allows visual confirmation of run progress and product level in the evaporator vessel. An agitator 128, coupled via drive hub 134 to a gearbox 130 driven by an electric motor 132, provides a means of mixing feed material inside the evaporator vessel. As an example, the agitator may be mounted through a bottom portion of the evaporator vessel. In another example, the agitator may be mounted through a top portion of the evaporator vessel, with the gear box and electric motor mounted on a top external surface of the vessel. A variable frequency drive 109, connected to the electric motor via a cable connection 133, allows the agitator to be operated at desired speeds. A housing 137, mounted to a side portion of the evaporator, contains one or more sight glasses and instrumentation ports for monitoring run progress, product levels, and operating parameters in the evaporator. As an example, the housing may include a plurality of ports that allow sight glasses, instrumentation or fixtures to be affixed to the side portion of the evaporator vessel. The ports may allow external to internal access during and after production.

Pivots 110 may be attached to the evaporator vessel, allowing the vessel to tilt from one side to another after the system has been shut down. For example, the pivots may be securely attached to a support frame 116; having bottom supports or casters 118 mounted on a flat surface. A hollow annular region formed in between external wall 115 and internal wall 117, holds a heating fluid 121 which circulates between the evaporator and thermal heater unit 148 via connection lines 170 and 172. For example, temperature of the heating fluid may be controlled by increasing a heater temperature set point, allowing feed material inside the evaporator vessel to be heated during operation. Further, an insulation layer 226 may be attached to the external walls of the evaporator vessel to reduce heat losses from the vessel.

Distillation unit 122 may be coupled to outlet 108 formed through the removable cover 102 placed on a top most portion of the evaporator vessel. A transition tube 124, connected to front end 184 of the distillation unit, conveys distillate from the distillation unit to a vertical condenser column 125 which is connected to a distal end 186 of the transition tube. The condenser column is connected to a chiller unit 152 via connection lines 174 and 176 such that cooling fluid can circulate between the condenser and chiller. Further, the chiller is connected to a switch unit 150 which allows the chiller to provide cooling capacity across a broader range of temperatures. A bottom portion of the condenser column is connected via joint 188 to a collection system comprising collection tanks 126 and 127. A valve 112 mounted between collection tanks 126 and 127, allows the distillate from 127 to be emptied into a storage vessel whilst the production system is still operating and the distillate is collecting in 126. The collection system is connected to a vacuum pump 146 via connection lines 178 and 180.

During operation, a product vapor produced from a feed material in the evaporator, flows through the distillation column 122 where the vapor is fractionally separated into various product compounds. As an example, the feed material may include a solution or feedstock containing cannabinoids. Subsequently, the separated product compounds are conveyed via transition tube 124 to the condenser column 125 where the product vapor is cooled and condensed before being delivered to the collection tanks 126 and 127. Finally, the product may be further conveyed from the collection tanks to one or more storage vessels. Details of system components are disclosed with reference to FIGS. 2A-5E.

In this way, the production system may comprise the evaporator, distillation apparatus, transition tube, condenser unit, and collection system. By using the production system disclosed herein to process cannabinoids and related compounds, process efficiency may be improved by combining evaporation and distillation process, and providing adequate control of system operating parameters such as temperature, pressure etc.

Now turning to FIGS. 2A-2C, a schematic depiction is shown of example configurations 201-206 of an evaporation vessel used for distilling a cannabinoids and related compounds. Embodiments 201, 203 and 205 show a plan view of the evaporator vessel depicted in FIG. 2A, FIG. 2B and FIG. 2C, respectively. Alternative embodiments 202, 204 and 206 show a front elevation of the evaporator vessel depicted in FIG. 2A, FIG. 2B and FIG. 2C, respectively. The evaporator vessel may be used in a production system, such as shown in FIG. 1. As shown, each example vessel configuration 202 and 204 depict the evaporation vessel with a top removable cover 102 and a bottom vessel 103. Example vessel configuration 206 depicts the evaporation vessel with a fixed cover, and a top manway 220 and lower side manway 136 for vessel access. The vessel configuration 206 may be used in larger iterations of the evaporator. Each evaporator vessel is externally mounted to a rigid light frame 116 which is held together by joints 212. The rigid frame allows the vessel to be securely attached to either rolling casters, or a fixed platform or ground surface via bottom supports (such as supports or caster 118 at FIG. 1).

Each of the vessel configurations 202, 204 and 206 may be provided with a belt or gear reduction drive comprised of gear box 130 driven by motor 132. As an example, the gear box and motor may be mounted on a bottom portion of the evaporation vessel as depicted in vessel configuration 202 and 204. In another example, the gear box and motor may be mounted on a top portion of the evaporation vessel, as depicted in the vessel configuration 206. The gear drive may be operated in a speed range of 10-300 rpm to turn the agitator. For example, the gearbox may be connected to a high speed motor, the gearbox providing a means of modulating output speed to provide adequate torque to operate the agitator.

As depicted, the example vessel configurations 201-206 may be designed and sized differently. The vessel configurations 201-204 may be better suited for a smaller evaporation unit, with a volume of less than 250 L. In contrast, the vessel depicted in embodiments 205 and 206 may be typically suited for large evaporation units, classified as vessels with an internal volume of greater than 300 L. Large evaporation units are bulky and may be difficult to tip during cleaning. Therefore, these large units may be configured with a bottom drain port 209 and manways 220 and 136 for easy cleaning access.

As shown in vessel configuration 202, agitator blades 128 are mounted in the bottom portion of the evaporation vessel. This design of simple wiper blades may be used in smaller evaporation vessels. The blades provide radial spreading of viscous oil in the bottom portion of the vessel, as well as thorough circulation of the oil pool. Similarly, agitator blades 128 of evaporator vessels shown in vessel configurations 204 and 206 are mounted in the bottom portion of each vessel, with wiper arms 131 extending upward towards an interior region of the vessel. As an example, the blades in the vessel configurations 204 and 206 may be longer than the blades provided in the evaporator vessel in embodiment 202.

The agitator in vessel configuration 206 is mounted from above the evaporation vessel to facilitate easy draining of potentially viscous products though the drain port. A wiping agitator blade with extended arms serves several functions. First, the blade wipes oil that accumulates at the bottom of the evaporator vessel and spreads the oil radially out into a thin film. The agitator is designed to adequately mix the viscous oil even when the oil in the evaporation vessel contains minimal to no solvent. The agitation of the viscous oil ensures adequate removal of solvents from raw product material, discourages bumping phenomena, and leads to cleaner distillate fractions. In addition, the agitation of the viscous oil increases heat transfer rate to the mixed material. The bumping phenomena, typically observed in vacuum distillation methods, is a sudden surge boiling of a large portion of media inside the evaporation vessel. This phenomena negatively impacts the performance of vacuum distillation systems. The wiper arms 131 touching sidewalls of each vessel contain channels intended to lift the oil vertically up the evaporator wall, in order to provide more circulation and an even thinner film-like distribution. As an example, the blades may be comprised of stainless steel, each blade having a thin contact wiping edge 233 comprised of polytetrafluoroethylene (PTFE) or another food-grade, low-friction, high-temperature and durable material. The wiping edges may be replaced easily or removed altogether if a small gap between the blades and bottom of the evaporator is required.

Different distillate fractions may be separated out of the distillate based on boiling points of the constituents in the mixed media. Separation of each distinct distillate fraction is dependent upon quality of media mixing. The internal and external walls of the evaporation vessels are configured with a space that contains the thermal fluid jacket 224 and insulation material 226 which enables the rate of heating of media in the vessel to be precisely controlled. The thermal fluid jacket and insulation materials also serve as a safety feature, since the temperature of the heating fluid may be elevated, typically 250 Celsius. All the three vessel configurations can be fitted with spray nozzle 222 to increase production capacity of each vessel. For example, the spray nozzle may be provided to introduce solutions containing a dilute product concentration into the evaporation vessel. As an example, the evaporator may be filled with a solution containing 95% solvent and 5% cannabinoid compounds. The evaporator vessel may be completely filled with the mixture at the beginning of a batch run, but if the spray nozzle is not used, then it will only contain 5% of its total volume at the end of the operation. The nozzle may be used in this case to load additional feed material into the evaporator during vessel operation, increasing the amount of material that can be recovered in each batch. In this manner, the evaporator may be operated continuously for a longer duration before unloading oil extracted from the feed material.

The vapor outlet 108 is sized with an adequate diameter to permit product vapor to escape with negligible pressure drop during vessel operation. The negligible pressure drop experienced during operation is defined as a pressure drop of less than 3% of an operating pressure. In smaller evaporator vessels (e.g., with a vessel volume in a range of 50-150 L), outlet 108 may be sized with an inner diameter larger than 2.0 inches. In other examples, the inner diameter of outlet 108 may range from 4.0 inches to 6.0 inches. In contrast, outlet 108 in larger evaporator vessels (e.g., with a vessel volume greater than 300 L), may be sized with an inner diameter greater than 24 inches. As an example, the inner diameter of the vapor outlet 108 may directly correspond to the internal diameter of a vapor conduit (such as vapor conduit 124 at FIG. 1). In one example, the outlet 108 may comprise a high strength material such as stainless steel. The outlet may terminate in a sanitary, flanged, or welded fitting.

Each evaporation vessel is fitted with two or more sight glasses, 106 and 107, which allow an operator to shine a light through a first sight glass, and look into the evaporator body through a second sight glass. The sight glasses provide the operator with a means of visually monitoring progress of an operation run during product preparation. As an example, internal diameter of the sight glasses may be sized to range from 2.0 to 10 inches. The sight glasses may be sealed to resist both full vacuum and limited operational pressure. Utility ports 109 mounted inside housing 137, may be used for mounting additional instrumentation such as temperature or pressure transmitters, or connecting a fill hose or other desired apparatus. As an example, the utility ports provide a small degree of customization for particular applications.

The small evaporator vessels are typically fitted with a fully opening cover 102, because it allows the operator optimal access to an interior region of the vessel. Evaporation vessel configuration 202 shows the removable top most cover 102 without a lifting aid, suited for small vessels due to light weight of the cover. As an example, the removable top most cover may be fitted with handles to enable ease removal and placement of the cover. Evaporation vessel configuration 204 shows the top cover 102 with an opening or lifting mechanism 105. The lifting mechanism is comprised of a simple cam and metal handle that facilitates lifting and pivoting of the cover. As an example, the opening arm 105 may have a downward extending portion 111 that may be held when lifting the removable cover from the evaporator. In one example, the lifting arm may be comprised of a pneumatically, hydraulically, or manually operated vertical slide combined with a single or double hinge mechanism. In another example, the lifting arm may be pivoted about the hinge mechanism to open the cover, allowing access to an interior region of the vessel. In another example, the cover may be opened and locked into an open position using the tilting motion of the evaporator vessel. In other examples, the lifting arm may be welded onto the lid and the body, but could conceivably be bolted into place as well.

As shown in vessel configuration 202 and 204, top most removable cover 102 may be a commercially produced manway. As an example, each top cover in vessel configuration 202 and 204 and 206 may be composed of stainless steel designed to withstand full vacuum pressure. In another example, each top cover may be dome shaped or less preferably a flat plate in profile, and affixed to the top of the evaporator vessel with swing-bolt closures or clamp style closures (not shown). The top cover may be insulated, but usually smaller lids are not insulated due to minimal energy savings, which may not justify the additional cost of including insulation in the top cover. In vessel configuration 206, a large top cover 102 may be supplied. As an example, the top cover of the vessel may be comprised of stainless steel, and configured with dome shape to support large pressure differentials within the vessel due to vacuum operation. The top cover may be fitted with sight glass 106, vapor outlet 108, manway 220, and an agitator having blades 128. As an example, the vapor outlet may be mounted through a side portion of the vessel, and the manway may comprise a large opening formed in the top removable cover to allow access to the interior region of the evaporator. The agitator may be mounted on a steady bearing axially coupled to drive shaft 134 which extends down into a bottom portion of the vessel. The agitator blades 128 may be similar to blades used in the smaller evaporator vessels depicted in the embodiment 204. The thickness of the domed cover usually may be increased to support weight and torque generated by the larger agitator.

Evaporation vessels with an internal volume of less than 200 L, such vessels depicted in vessel configurations 202 and 204 may be fixed to frame 116 via pivotable stand 110 comprised of stainless steel or mild steel. The vessel may be approximately balanced, while allowing for tilting motion along tilt axis 214, which enables an operator to access the interior region of vessel during and after operation. As an example, the stand may be optionally constructed with a set-screw or locking-pin mechanism that allows the operator to stop the vessel in a variety of positions. This enables the operator to choose an optimum position for cleaning the vessel or removing the product from vessel bottom. Larger evaporator vessels (e.g., with internal volume greater than 250 L) may not be fitted with the pivotable stand, because the vessel may be too bulky to be manually rotated safely. In this case, the vessel may be fitted with rigid legs 116 that have enough additional ground clearance to allow easy removal of the viscous product via the bottom drain.

Rolling casters may optionally be fitted to the legs or rotating stand of each evaporator vessel of configurations 202, 204 and 206. The casters may possess locking brakes, and may be used during initial setup or removal of the vessel system. As an example, the rolling casters may provide a means of moving the apparatus if no forklift, pallet-jack, or other hydraulic means is available.

The insulation jacket 226 provides superior energy efficiency and ensures operator safety as compared to use of the thermal fluid jacket 224 alone. The temperature of the heating fluid may rise up to 350 C during normal vessel operation, and pose hazardous conditions to the operator if accidentally touched. The embodiment of the vessel disclosed herein may possess an insulation jacket (1.5 inches thick, for example), which provides additional safety, and ensures that minimal heat is lost to the surroundings. Other thicknesses of insulation may be used if desired.

As shown in vessel configuration 206, lower manway 136 provides operator access for product removal or cleaning. For example, the lower manway may be an opening sized to ensure that the operator can easily reach the bottom of the vessel. In one example, the opening of the manway may be sized to allow the operator to enter and exit the vessel, if necessary. A latch attached to the manway, may automatically send a stop signal to a programmable logic controller (PLC) to disenable the agitator when the manway is opened. The manway may be comprised of stainless steel, and usually welded onto the side of the evaporator vessel. A top manway 220, typically smaller than the lower manway 136, may be included on larger evaporator vessels. As an example, a diameter of an opening in the bottom manway may be selected to range from 16-28 inches. The top manway provides additional access to the evaporator during cleaning or loading feed material. For example, the top manway may typically be sized with a diameter in a range of 8-20 inches. In one example, the top manway may be comprised of stainless steel, and welded to the top cover 102.

Turning to FIGS. 3A-3B, schematic depictions are shown of example distillation apparatus 300 and 301 used for processing a cannabinoid product. As shown, the distillation apparatus comprises dephlegmator 302, transition portion 304, and distillation column 306. The dephlegmator 302 has a cooling fluid inlet 312 and cooling fluid outlet 314. In embodiment 300, the distillation column and dephlegmator unit may be attached to the transition piece at junction 310 and 311, respectively via a suitable fastener or permanently welded. Likewise, in embodiment 301, the transition piece and the distillation column may be attached to the dephlegmator unit at junction 311 and 313, respectively via a suitable fastener or permanently welded.

As depicted in a first embodiment 300, vapor from an evaporator vessel (depicted by arrow 308) is conveyed through the distillation column 306 via main inlet 320. Subsequently, the vapor passes through the transition piece 304 and exits through main exit 322 as depicted by arrow 316. In an alternative embodiment 301, vapor from the evaporator vessel passes via the main inlet 322 and is conveyed into the distillation column 306. Subsequently, the vapor flows through the dephlegmator 302 before passing through the transition piece 304 and exiting through the main exit 322 as depicted by arrow 316.

As shown, the distillation apparatus conveys product vapor from the evaporator vessel to the condenser. The distillation apparatus 300 and 301 may refine the product vapor to provide better separation of desirable compounds in the vapor. Optionally, if the operator chooses not to refine the product vapor, then the packing or distillation trays 315 may be removed from distillation column 306, and cooling fluid may be shut off to the dephlegmator 302. In the first embodiment, the distillation apparatus may comprise the distillation column 306 to convey the product vapor to the condenser. As an example, the distillation column may be insulated or uninsulated without dramatically affecting the functioning of the distillation apparatus. The distillation column is sized with a suitable diameter and length to minimize pressure drop between the evaporator vessel and condenser, which may affect the efficiency of the distillation process. For example, a distillation column with a large diameter may be selected to minimize or reduce the pressure drop, such that the pressure in the condenser may be approximately similar to the pressure in the evaporator vessel. In one example concerning small evaporators of 150 L volume or less, an internal diameter of the distillation column may be larger than 2 inches, and a column length of less than 10 feet may be selected to minimize pressure drop between the condenser and evaporator vessel. In other examples, a distillation column with an internal diameter of up to 24 inches and a column length of 1.0 foot may be selected to ensure negligible pressure drop between the condenser and evaporator vessel.

The distillation column may be comprised of stainless steel, but a suitable food grade material capable of tolerating large temperature and pressure differentials may be used. For example, the distillation column may be designed to withstand heat differentials of up to 500 Celsius and pressure differentials of up to 30 PSID. Connections between the distillation column and the evaporator vessel may be permanent and welded. Alternatively, the distillation column and the evaporator may be connected together with removable fitting securely fastened with bolts, or other suitable fasteners. As an example, a sanitary style clamp fitting may be used to connect the distillation column to the evaporator vessel. Similarly, the distillation column may be connected to the condenser with a sanitary clamp style connection or permanently welded.

In the second embodiment, the distillation apparatus may be used to refine the product vapor exiting the evaporator vessel. The distillation column 306 and dephlegmator 302 are used to refine the vapor before it enters the condenser. The dephlegmator is a shell-and-tube type heat exchanger through which a cooling fluid (typically cooling water or a glycol-water mixture) is flowed through the shell side, while the product vapor is delivered through the tube side. The tube side in the dephlegmator is designed to drain adequately, and ensures that viscous products do not accumulate inside the dephlegmator or distillation column. In this embodiment of the distillation apparatus, the distillation column may be either a multiple tray or packed-column. As an example, the multiple tray column may be used in larger distillation apparatus where the distillation column diameter is equal or greater than 3.0 inches. The packed column may be filled with unstructured packing materials such as Raschig rings, or a suitable structured packing material.

FIGS. 3C-3D show plan views of the distillation column containing a sieve tray (such as sieve tray 315 shown in FIG. 3A) and the distillation column containing a structured packing material, respectively. FIG. 3E shows a plan view of the shell-and-tube configuration of the dephlegmator shown in FIGS. 3A-B. As shown in FIG. 3A, the sieve tray style distillation column 306 comprises an internal region with sieve trays 315 oriented horizontally and vertically spaced above one another in increments of 1-10 inches, for example. The sieve trays 315 may be comprised of a perforated metal disc of stainless steel or another food grade material. The sieve trays may contain a down comer 309 which allows excess buildup of condensed distillate vapors to drain through the plate, as shown in FIG. 3C. The down comer may be a stainless steel or other food grade tube that descends from a first plate to a second plate mounted directly beneath the first plate. Alternatively, the distillation column 306 may contain a form of structured packing material 317 such as an ordered stainless steel mesh, or ordered layers of ceramic fibers, as shown in FIG. 3D. The sieve trays or structured packing provides surfaces or zones of high mass transfer between the condensed and refluxed distillate product and the incoming product vapor. The high mass transfer rate provided by the structured packing or distillation trays increases the concentration of lower boiling point or more volatile compounds in the product vapor. In the embodiment 300 of the distillation apparatus, the dephlegmator 302 may be positioned above the transition section 304 so that product vapor reaches the condenser without having to pass through the dephlegmator. In the alternative embodiment 301, the dephlegmator may be positioned between the transition piece 304 (containing the vapor outlet), and the distillation column 306. As shown in FIG. 3E, the dephlegmator unit may be provided with a plurality of cylindrical tubes 307 placed inside an interior region 305, that circulate a cooling fluid within the unit via inlet 312. As an example, the cylindrical tubes 307 may be geometrically arranged inside the dephlegmator unit, with each tube evenly spaced with respect to surrounding tubes. In other examples, the cylindrical tubes may be randomly arranged within the dephlegmator unit. The different positions of the dephlegmator unit do not introduce significant changes in the distillation apparatus or product process.

Referring to FIGS. 4A-4B, a schematic depiction is shown of example condenser systems 400 and 401 used in a distillation process of a cannabinoid product. FIGS. 4C-4D show alternative views of the condenser unit depicted in the embodiment 400 and 401, respectively. As shown, the condenser in embodiments 400 and 401 comprises a condenser column 402 with a cooling fluid inlet 406 and outlet 404. In FIG. 400, an inner region 405 of the condenser column contains one or more cylindrical tubes 408. The condenser receives product vapor (as depicted by arrow 416) from a transition piece (such as transition portion 304 in FIGS. 3A-3B) via inlet 410. Once the product vapor enters the condenser column, the vapor cools down and condenses into a liquid that is subsequently collected in a collection system (as depicted by arrow 418) connected to the condenser (such as collection system 126 in FIG. 1). As an example, the condenser column may comprise a shell-and-tube type heat exchanger that provides a means of cooling the product vapor into liquid before collection. Depending on viscosity of the product, a single tube-in-tube heat exchanger may be preferred as depicted in FIGS. 4A and 4C. In this case, the heat exchanger may comprise an internal tube 408 mounted inside internal region 405 of the condenser column 402. In one example, the internal tube may be sized with a diameter that ranges from 1 inch to 16 inches, while the column diameter may range from 2 inches to 18 inches. In other examples, a multiple tube heat exchanger (such as heat exchanger in FIGS. 4C-4D) may be used when distillate viscosity is low enough that the tubes will sufficiently drain by the force of gravity. The multiple tube heat exchanger may comprise multiple tubes 408 mounted inside the condenser column. As an example, the multiple tube heat exchanger may contain a plurality of tubes with diameters ranging from ⅜ of an inch to 6 inches mounted inside an interior region 405 of the condenser column with a diameter of 3 inches to 30 inches. In another example, the tubes 408 may be geometrically arranged inside the condenser column, with each tube evenly spaced with respect to surrounding tubes. In other examples, the tubes may be randomly arranged inside the condenser column.

The inner tube and column used in both types of heat exchangers may be selected to have lengths ranging from 12 inches to 84 inches or conceivably longer. A cooling fluid (such as water or a glycol-water mixture) may be flowed through the shell side of the heat exchanger to provide a means of cooling the condenser. The product vapor flowing through the tube side of the heat exchanger is converted into liquid form by the cooling fluid that flows around an outer surface of the inner tube, absorbing heat from the product vapor.

Referring to FIGS. 5A-B, a schematic depiction is shown of example distillate collection systems 500 and 501 used in a production process of a cannabinoid product. As shown, each embodiment includes collection systems 126 and 127 which comprise two cylindrical hoppers 502 with an inlet 504 and outlet 510. The inlet 504 is formed through a cover 506 mounted on a top portion of each collection system. A vacuum source valve 505, mounted through the top cover on collection systems 126 and 127 in embodiment 500, is connected to a vacuum source or vacuum pump. A vent valve 514 is mounted to the top cover of the hopper in collection system 127. The hopper in collection system 127 of the embodiment 501 may include a vacuum source valve 515, connected to a vacuum source or vacuum pump. Further, valves 514 and 515 may be connected to a programmable logic controller (PLC) via communication 521, allowing each valve to be automatically operated. A slight glass 507 may be attached to a mid-section of each hopper in collection systems 126 and 127 to monitor distillate levels.

In each embodiment 500 and 501, the outlet 510 is formed through a conical bottom portion 508 of the hopper in collection system 127. A valve 512 is mounted between the outlet 510 of collection system 126 and inlet 504 of collection system 127. For example, the valve 512 may be a ball valve or check valve. The collection system in embodiment 501 includes level sensors 520 and 522 connected to the PLC via communication lines 525 and 527, respectively. As a result, the collection system in the embodiment 501 may be automatically operated using the PLC, which receives signals from the level sensors via communication lines 525 and 527 and actuates valve 513 via communication line 519, and further actuates valves 514, and 515 via communication line 521.

The inlet 504 of the hopper in collection system 126 may be connected to an outlet of condenser 402, allowing the product to accumulate in the collection system before being emptied into separate storage vessels (as shown by arrow 530) via outlet 510 of collection system 127 by opening control valve 513. The separate storage vessels are maintained at atmospheric pressure. As an example, each configuration of the collection system may contain a portion that is maintained under vacuum pressure to allow uninterrupted product collection. In another example, the collection system may be automated to allow semi-continuous removal of product during system operation. In other examples, the collection system may be manually operated when separating different distillate fractions from the product vapor. The collection systems 126 and 127 may comprise vertically stacked stainless steel tanks. As an example, the vertically stacked tank configuration may be suitable for bulk solvent recovery, or fractionation of compounds that are not highly viscous. The tanks may be heated to enable sufficient drainage of viscous distillate compounds. Alternatively, a different type of collection system may be used to collect separate fractions of the product without heat application to the tank as disclosed further with reference to FIG. 5C.

Each tank 502 of the collection system in embodiments 500 and 501 may be sized with a volume of approximately 5-30% of a volume of the evaporator vessel. Each tank may be fitted with a conical or domed bottom to prevent liquid or viscous product from pooling in the bottom of the tank. In other examples, a flat bottom may be provided to collect non-viscous liquids as well. The tanks are fitted with a sight glass that allows the operator to visually monitor the level inside the distillate level in the tank. As an example, the sight glasses may be face mounted circular sight glasses or vertically oriented tubular sight glasses used in commercial boilers. Coupling connections at the inlet and outlet of each collection tank may comprise sanitary clamp fittings to allow modular interchange with different types of collection systems.

In embodiments 500 and 501, collection tank 126 may be large enough that the distillate does not backup into the condenser when tank 127 is being emptied and control valve 512 is closed. Inlets 504, outlets 510, and control valves 512 and 513 are sized large enough that no significant pressure beyond that generated by gravity and static liquid head is required to drain all the distillate from one section to the next during a nominal venting cycle. A nominal venting cycle is the duration taken to remove the product from the collection vessel 127 to the storage vessels. Gravity may be used to drain the product from condenser outlet 412 through inlet 504 and into vessel 126. Again, distillate from vessel 126 drains through outlet 510 and then through control valve 512. Subsequently, the distillate flows with the aid of gravity into inlet 504 of vessel 127. The distillate is further conveyed via gravity through outlet 510 of vessel 127 and control valve 513, where the product is conveyed to a storage vessel in direction 530. As an example, the tank inlet may have an internal diameter equal or greater than 25% of the nominal diameter of the condenser column. The first collection tank may be fitted with the top cap to contain the product within the tank. For example, the collection tank may be fitted with a flat cap if an external diameter of the tank is smaller than 24 inches. In other examples, the collection tank may be fitted with a domed or conical cap when the tank diameter is larger than 16 inches.

The first and second collection tank may be vertically connected via a manually operated ball valve or a check valve 512, such that the distillate in the first collection tank drains into the second collection tank without any pooling or retention of distillate in the first tank. As an example, a suitable check valve may be provided with a low cracking pressure and a bore diameter large enough to allow the entire contents of the first collection tank to drain into the second collection tank during the venting period. The small cracking pressure insures that all the distillate from the first collection tank drains into the second collection tank. In another example, a manually operated ball valve may be provided as long as the valve meets similar flow requirements as the check valve.

The second collection tank (in collection system 127) in the embodiments 500 and 501 may be sized in a similar manner as the first collection tank in collection system 126. As an example, an evaporator vessel with a volume smaller than 300 L may be connected to a dual tank collection system with identical first and second collection tanks. In this case, manufacturing two identical tanks leads to reduced costs compared to fabricating different size dual collection tanks. In larger evaporator vessels, however, it is more cost efficient to manufacture two collection tanks of different sizes. For example, the second collection tank may be selected to be larger than the first collection tank, allowing the operator to perform less frequent venting cycles. The first collection tank may be large enough to hold the distillate produced during the venting cycle, which may be less than 50 L. The second collection tank may be sized to hold several hundred liters, allowing the operator to empty the tank less frequently.

Manual removal of the cannabinoid or solvent distillate product from the collection system 500 involves several steps that occur around a venting cycle. First, the operator checks the distillate level in the second collection system 127. If the distillate level is above a collection threshold, then the collection system 127 may be emptied into a storage collection tank. First, the vacuum source valve 505 (mounted on collection system 127 only) hooked to a vacuum source and controlled via a manual ball valve, may be shut off by closing the valve. Also, if valve 512 is a ball valve, then valve 512 may be closed to stop flow of distillate from collection system 126 to collection system 127 before venting begins. Otherwise, if the valve 512 is a check valve, no valve closing is necessary. A vent valve 514 is then opened to allow the pressure in the second collection tank to reach atmospheric pressure. Next, the valve 513 may be opened to allow contents of the second collection tank 127 to drain into an atmospheric storage vessel or a pump inlet. In cases where valve 513 is a check valve instead of a ball valve, the distillate flows automatically when vent valve 514 is opened. Once the second collection tank is empty, valves 513 and 514 may be closed. The vacuum source valve 505 is opened again, and the second collection tank 127 is allowed to reach operating vacuum level. Control valve 512 may then be opened again if it is a ball valve. If control valve 512 is a check valve, then any distillate collected during the venting cycle will drain from collection system 126 into collection system 127 without any further actions. The venting cycle may be repeated once the distillate level in the second collection tank exceeds the collection threshold level again.

When used for collection of viscous cannabinoid distillates, extra care may be needed when sizing ball valves and collection tanks of collection systems 126 and 127. The tanks may be heated to ensure clean and proper draining of the viscous compounds, for example. In some cases, the distillate may too viscous for appropriate use in collection systems depicted in embodiment 500 and 501, in which case a type 540 collection system may be used.

In an automated collection system 501, control valve 512 may be a check valve or automated ball valve. In addition, automatic valves are provided to control a vacuum source valve 515, vent opening 514, and drain valve opening 513. For example, the automatic valves may be solenoids or automatically operated ball valves, and may be controlled pneumatically or with electric actuators. Optionally, if the vacuum source valve (e.g., vacuum source valve 505 shown in FIG. 5A) is provided, the valve may be adjusted to close with a cap, or an additional pressure transmitter, and adjusted to open by removing the cap. The collection system 127 may contain two float switches, low voltage level sensors, or proximity sensors 520 and 522 that send signals to the programmable logic controller (PLC). The sizing and construction of the collection tanks in the automatic collection system in embodiment 501 may be similar to design specifications in the manual collection system disclosed with reference to embodiment 500.

In embodiment 501, transfer of the distillate from the collection system 127 into a storage collection tank or pump inlet involves several steps that are disclosed herein. The collection system is connected to the condenser outlet and distillate is allowed to flow into the collection tank 126. During operation, the distillate flows into the collection tank 127 via check valve 512 or normally open automatic ball valve 512. The collection tank 127 begins to fill until the high level sensor 522 indicates that a threshold collection level has been reached. The PLC closes the vacuum source valve 515 and opens the vent valve 514. The PLC also closes control valve 512 if it is not a check valve. Then, the PLC opens the drain valve 513, allowing the distillate to flow from collection system 127 into the storage vessel. Once the distillate level in the collection tank 127 reaches a low threshold level, the low level sensor 520 sends a signal to the PLC which then closes the drain valve 513. Also the PLC may then close valve 514 and open valve 515, allowing vacuum level to build up in the collection tank 127. Once vacuum level returns to the operating level, the PLC opens control valve 512 if necessary. Vacuum level inside the production system is maintained throughout this process via valve 515 on collection system 126. This venting cycle may be repeated several times until there is no more feedstock to evaporate in the evaporator vessel, or until the evaporator is shut down.

A third embodiment of the collection system 540 may be used to collect separate fractions of highly viscous cannabinoids and associated compounds as shown in FIG. 5C. As depicted, the collection system comprises a conical reducer 503 to receive the distillate from condenser 402. An outlet 511 of the conical reducer is mounted above an inlet 516 of a pipe network 517 that has a three-way valve 515 that controls flow of distillate to three separate collection tanks 502 (e.g., a first, second and third collection tank) via each tank inlet 504. Each collection tank has a sight glass 507, for monitoring a level of distillate in each tank during distillation operation. The first, second and third collection tank may be provided with vacuum valves 535, 536 and 537, respectively, each vacuum valve connecting each first, second and third tank to the vacuum source. Further, the first, second and third collection tank may be provided with vent valves 538, 539 and 540, respectively that allow each collection tank to be adjusted to atmospheric pressure during distillate recovery. A control valve 513, coupled to a distal end of bottom conical section 508 of each collection tank, controls flow of the product from each tank to separate storage units, as depicted by arrows 542, 544 and 546.

In the third embodiment 540, three or more collection tanks may be provided to collect multiple, distinct fractions of cannabinoids. It is highly desirable to separate the first three fractions of the product. For example, a first fraction of the product, which typically boils at temperature range of 120-180° C. and a pressure of 0.1-2.0 mbar, is composed primarily of volatile terpene compounds. The second fraction contains the bulk of the cannabinoids, and boils at 150 C-300 C and a pressure of 0.001 mbar to 2.0 mbar. The last fraction contains compounds with boiling points higher than those of cannabinoids. As shown, the condenser outlet may be plumbed into the conical reducer 503 which then feeds into a 3-way directional valve 515. The conical reducer and subsequent piping 517 are insulated so that elevated temperature of the product exiting the condenser is maintained. For example, the condenser may be operated at a temperature between 40° C. and 80° C. to maintain lower distillate viscosity. When operated at these temperatures, the viscous compounds comprising the product flow easily into the collection tanks.

The first, second and third collection tanks may be selected to have a similar size, each tank with a conical bottom connected to a ball valve outlet of a similar design to enhance product removal. For example, if the product is produced in small evaporator vessels (e.g., with volume less than 300 L), then identical collection tanks with the same capacity may be selected for collecting the distillate because it is easier to manufacture more identical tanks than several tanks of different sizes. In one example, each collection tank may be sized with a volume less than or 20% of a total volume of the evaporator vessel. In another example, collection tanks connected to large evaporator vessels may be selected to have different sizes because it becomes more economical to manufacture tanks of distinct sizes rather than three identical tanks when more collection capacity is required. In one example, three collection tanks with different volumes may be provided to collect different fractions of the product. A first collection tank, selected to collect a terpene fraction, may be sized with a volume 50% smaller than a second and third collection tanks, for example. The second and third collection tanks may be similar in size and used to collect the bulk of the product. Each collection tank may contain sight glasses for checking product levels. In third embodiment 540 of the collection system, standard sanitary clamp inlets and outlets may be provided to facilitate connection or disconnection of the collection tanks. The use of the standard fittings allows for modular interchange of various components needed for performing different operations during product processing.

The product may be collected using embodiment 540 of the collection system as disclosed herein. First, the operator may switch on the evaporator vessel and then actuate the directional valve 515 to direct flow of the product to a collection tank designated to collect a lighter volatile fraction of cannabinoids or a first fraction of recovered solvent. In this example, the first collection tank is pictured furthest to the left in embodiment 540. The evaporation vessel produces a distillate which is delivered to the condenser, and then fed through the conical reducer where the product is conveyed to pipe network 517 through pipe inlet 516. The product is further conveyed from the pipe network 517 via the directional valve 515 to the first collection tank until the tank is gradually filled with either terpene rich compounds or recovered solvent.

Next, the operator actuates the directional valve to direct flow from the conical reducer 503 to the second collection tank, mounted at the right side of the first collection tank. Valve 535 is closed to disconnect the vacuum source from the first collection tank. Vent valve 538 may then be opened to adjust pressure inside the first collection tank to atmospheric pressure. Subsequently, product recovery valve 513 is opened to allow first product to exit the collection tank and flow in storage vessel 542. Alternatively, the first collection tank may be entirely removed from the collection system 540, emptied, cleaned, and then returned to service. Once the second collection tank is emptied, the directional valve 515 may be redirected to the third tank on the far right, and then the second tank may be depressurized according to an analogous procedure disclosed with reference to the first collection tank. The third collection tank may be used to collect the remaining product, or either of the first and second collection vessels may be returned to service, and used to collect more distillate if required.

A fourth embodiment 548 of the collection system may be used to manually collect unfractionated cannabinoids and associated compounds or bulk solvent as shown in FIG. 5D. As depicted, inlet 504 of collection tank 502 is mounted below condenser 402 to allow delivery of the distillate from the condenser to the collection tank. The collection tank may be connected to the vacuum source via the vacuum source valve 505. The collection tank has one or more sight glasses 507, for monitoring a level of distillate in the tank during a distillation operation. A tank outlet 510, attached to a domed or conical bottom portion 523 of the collection tank, is connected to a valve 513 that controls flow of the product from the collection tank into a storage vessel as depicted by arrow 530.

The collection system 548 may be used for large scale solvent or product recovery. For example, a single tank sized with a volume of up to 100% of a volume of an evaporator vessel may be used to collect all the solvent in a single bulk batch. In another example, the tank comprising top portion 506, cylindrical middle portion 503 and domed bottom portion 523, may be comprised of stainless steel. The inlets and outlets of the collection system 548 may be comprised of sanitary clamp fittings, which allow modular interchange with different collection systems. The solvent may be pumped out of the collection tank under non-atmospheric conditions. For example, a pneumatic diaphragm pump may be used to convey the product to the storage vessel. The embodiment 548 of the collection system may not be suited for collection of distillate fractions or viscous compounds, and may be seldom used on a small evaporator vessel with a total volume of less than 300 L.

A fifth embodiment 550 of the collection system may be used to automatically collect cannabinoids and associated compounds or bulk solvent as shown in FIG. 5E. As depicted, a control valve 512 is coupled to a condenser 402. The control valve 512 is mounted above inlet 504 of collection tank 502 to allow delivery of the distillate from the condenser 402 to the collection tank. The collection tank may be provided with vacuum valve 538 connected to a vacuum source, and vent valve 539 connected to the atmosphere. Each vacuum valve 538 and vent valve 539, may be connected to the PLC via communication 521. The collection tank has one or more sight glasses 507, for monitoring the level of distillate in the tank during distillation operation. Low level sensor 520, attached to a bottom interior wall of the collection tank and connected to PLC 12 via communication line 525, provides a means to monitor if the product level is above a first threshold collection level. Similarly, a high level sensor 522 which is attached to a top interior wall of the collection and connected to the PLC via communication line 527, monitors if a product level exceeds a high threshold collection level. A pump inlet 526 of pump system 528 is mounted below a tank outlet 510, attached to a conical or domed bottom portion 523 of the collection tank, to receive the product from the collection tank. The pump system provides a pressurized means of conveying the cannabinoid product to a storage vessel (as depicted by arrow 530) operating under atmospheric or reduced pressure.

The collection system 550 may be used for very large scale solvent recovery operations. As an example, the collection system 550 may be fitted to semi-continuously operating evaporators which process solvent quantities exceeding 500 L per day. The collection system 550 is provided with low and high level sensors to monitor product levels in the collection tank. Depending on the product level in the tank, the sensors are configured to send a signal to programmable logic controller to turn on or off the distillate removal pump 528. The PLC may also send signals to the vent and vacuum source valves which allows the system to empty solvent without any operator interference. The embodiment 550 of the collection system may remove solvent under vacuum pressure, and may be adjustable to switch from the vacuum to atmospheric pressure or vice versa, without operator interference. As an example, the PLC may be a commercially available programmable logic controller. In another example, the low and high level sensors are low voltage liquid level commercial sensors or small float switches. In other examples, the vent and vacuum valves are pneumatically controlled or electronically operated solenoid valves. In alternative examples, the vent and vacuum valves may be automatically controlled ball valves or other shutoff valves. The collection tank may be sized in a similar manner as the collection tank disclosed with reference to the collection system 548.

The product may be collected using the collection system 550 as disclosed herein. First, the distillate from the condenser outlet is delivered in the collection tank via tank inlet 504. The check valve 512 allows the solvent to enter the collection system without pooling in the condenser. The collection tank is allowed to collect the product until the second threshold collection level 522 is reached. In this case, the high level sensor transmits a signal to the PLC which will turn on pump 528, and optionally close the vacuum valve 538 and open the vent valve 539. Since the collection system can be operated under vacuum conditions, the vent valve may remain closed during the collection operation. For example, the PLC may send the signal to turn on a pneumatic solvent removal pump. Pressure inside the evaporator vessel may begin to decrease when the pump is operated. The vacuum level monitoring systems on the collection tank may automatically open a bleed valve located near a vacuum pump to induce optimal pressure conditions in the tank. In this manner, solvent may be removed without altering or interrupting operating parameters of the overall collection system.

Once the solvent or distillate level falls below a first threshold collection level 520, the low level sensor sends a signal to the PLC to turn off the delivery pump. If the vent valve and vacuum source valves were actuated, the valves may be adjusted to their prior operating positions. Once the pump is turned off, the collection system may resume or continue collecting the distillate product. If the automatic valves 538 and 539 (that control the vacuum source and vent lines, respectively) where not actuated initially, then the valves may not be adjusted. Otherwise, the automatic valves may be adjusted to prior operating positions. The collection process may continue until the evaporator is full of viscous oil or distilled solvent. This type of operation usually uses a relatively large evaporator vessel (with a volume greater than 300 L), and a spray nozzle may be attached to the evaporator to allow delivery of additional dilute feed. In this case, the evaporator will first process the initial solvent batch, and then feed solvent/product mixture may be added into the evaporator vessel until a preset time-point or product mass level or solvent level is exceeded. For example, the values of preset time-point or product mass level or solvent level may be determined via a timer, load cell, or level sensor, respectively.

Referring to FIG. 6, a schematic depiction is shown of an example control system 600 used for controlling a production process for a cannabinoid product. As shown, the control system 600 comprises a programmable logic controller (PLC) 12, that sends instructions to the vacuum pump 146, variable frequency drive (VFD) 109, thermal fluid heater 148, switch 150, glycol chiller 152 and user module 606. The PLC also receives signals from pressure sensor 602, temperature sensor 604, and the user module 606. Instructions for controlling the operating parameters and the rest of the methods included herein may be executed by the programmable logic controller 12 based on instructions stored on a memory of the controller and in conjunction with signals received from sensors of the production system, such as the sensors described above with reference to FIGS. 1-5E. The controller may employ system actuators of the production system to adjust operations of various components of the system, according to the methods described below.

As shown, the PLC integrates signals from operator input via module 606, as well as signals from pressure sensor 602 and temperature sensors 604 mounted inside the evaporator vessel. The controller runs through a script containing computer code, and sends discrete commands to the systems components. The glycol chiller, thermal fluid heater, and switch contain a proportional integral derivative (PID) controller that receives a set point command from the PLC. The VFD controlling the agitator and the vacuum pump controller also receive set point commands from the PLC.

When the control system is first turned on, the PLC prompts the user for several set points. The first set point is based on a type of substance to be evaporated. For example, the substance may be a solvent, cannabinoid, terpene, or heavy oil. The system prompts the user to select a compound from a lookup table containing a list of possible compounds. Subsequently, the system prompts the user to input an approximate amount of product load by mass or volume. The user may decline to enter the initial information requested. Other programming options are also available. Based on the input information, the system may provide recommended operating parameters such as operating pressure, agitator rotational speed, set point temperature of the thermal heating fluid, set point temperature of condenser cooling fluid and process duration. The operator may choose to accept or modify the recommended system operating parameters. If the operating parameters are modified beyond a preprogrammed range, the system may ask the user to confirm the entered value. The user may also choose to run the system indefinitely, and ignore the suggested process duration.

The pressure sensor in the evaporator vessel sends an analog electric current signal to the PLC which continually processes the transmitted signal at speeds ranging from 10× per second to 1000× per second or more. These analog signals are usually in the range of 4-20 mA, or 0-5 v DC. Subsequently, the PLC may send signals to the vacuum pump controller and a venting solenoid valve based on the actual pressure in the production system and 5 logic points. The system may try to attain and maintain an optimal system set point. At absolute pressures below a set point pressure, two distinct pressure levels including a seal-threshold and open-threshold may exist. The open-threshold pressure is a lowest absolute pressure measured during production. If the production system reaches an open threshold pressure lower than the set point pressure, a vacuum vent valve may open to increase the absolute pressure inside the system. The seal-threshold pressure is a pressure level below the set point pressure but above the open-threshold pressure. At the seal-threshold pressure, the PLC may be actuated to close the atmospheric vent such that system pressure level does not exceed the set point pressure. Above the set point pressure is an on-threshold pressure. If absolute pressure inside the production system rises above the set point pressure and reaches the on-threshold pressure, the PLC may send a signal to turn on the vacuum pump at a pumping speed lower than its full capacity. Another actionable pressure level may be reached when the system pressure exceeds both the set point and the on-threshold pressures. If the absolute pressure in the system rises above a critical point pressure, the vacuum pump may be adjusted to operate at 100% capacity. As an example, the critical pressure is the highest pressure attained in the system. A pumping rate between the on-threshold and the critical point pressure is controlled by a fall-off rate, which may be programmed into the PLC.

In another example, the controller may be actuated to operate the pump and vent valves based on actual system pressure and the aforementioned parameters. If the system is above the set point and above the critical point, then the PLC sends a signal to keep the vacuum pump operating at full capacity. When the system pressure drops below the critical point, the PLC may signal the pump to operate below its maximal pumping rate. The decrease in pumping rate at absolute pressures below the critical point and above the set point, may be controlled by a fall-off rate that is directly proportional to a difference between an optimal set point and current system pressure. Both the critical value and fall-off rate are adjustable values that may be tuned by the operator using the user module. The pump may continue to operate below its maximal pumping rate until the set point is reached, and the PLC may be actuated to turn off the pump. The pump may be restarted when the absolute pressure inside the production system rises above the optimal set point and reaches the on-threshold pressure. If the actual absolute pressure in the evaporator is lower than the desired set point pressure, the PLC may be actuated to open the vent valve to increase system pressure. This process occurs when an open-threshold set point pressure is exceeded. For example, an open-threshold pressure may be set at an absolute pressure 5 mbar below the optimal set point pressure and a seal-threshold may be set 3.0 mbar below the absolute pressure set point. When the absolute pressure in the evaporator reaches 5.0 mbar below its set point pressure, the vent may open and remain open until the absolute pressure rises up to a seal-threshold pressure. Once the seal-threshold pressure is achieved, the PLC may be actuated to close the vent, and the system pressure reaches a value of 3.0 mbar lower than the set point pressure. In this manner, the controller may be adjusted to correct for pressure deviations above and below the process set point pressure.

As another example, an optimal system set point may be selected as 50 mbar for solvent evaporation. The critical point may be selected as 50 mbar above the set point pressure and a fall-off rate may be set to 0.75% per mbar. At a pressure of 100 mbar and above, the vacuum pump may be cycling at its maximal rate. At 90 mbar, the vacuum pump may cycle at 85% (100%−(1.5*10)%) of its maximal capacity. When the pump reaches 55 mbar, it is only operating at 32.5% of its maximal capacity. The pump may continue to cycle until the set point is reached, at which time the PLC signals the pump to turn off until needed. If the pump pulls a deeper vacuum level than is required (lower absolute pressure), the PLC may be actuated to open the vent connected to the atmosphere once an open-threshold is reached. If the open-threshold is set at a pressure of 2.0 mbar below the set point, then the controller may be actuated to open the vent only if the absolute pressure reaches or exceeds a value of 2.0 mbar lower than the set point. Once opened, the vent may remain open until the system pressure rises and reaches the seal-threshold. If the seal-threshold is set at 0.5 mbar below the set point, then the vent will remain open and the system pressure will rise until the pressure reaches a value of 0.5 mbar beneath the set point pressure. At this point, the PLC sends a signal to close the vent and the pressure stabilizes. The system pressure may increase beyond the set point, in which case it may reach the on-threshold pressure, and a regular pump down operation will resume. The on-threshold pressure may be set a 3.0 mbar above the set point, for example.

When the production system is operated at pressures below 2.0 mbar, the vacuum pump and PLC control system may operate in a different mode. The vacuum pump may operate continuously, and the vacuum level inside the system may be controlled using the vent valve, a control valve and the PLC. As an example, the control valve may be mounted between the collection system and vacuum pump. The PLC may continuously monitor the vacuum level inside the production system, and modulate the vent and vacuum source valves to maintain ideal system pressure.

The pressure set points are then transmitted by the PLC to the other PID controllers and system components. For example, the PLC may send a set point pressure to the variable frequency drive, which controls the agitator rotational speed. The set point pressure may be directly selected by the operator via the user module. The set point is not altered by the PLC during operation unless the operator enters a new rotational speed set point in the user module, or unless the system goes out of normal operating bounds, in which case the PLC sends signals to shut down the system.

The PLC may transmit information on a set point temperature to the thermal fluid heater based on operator input. The operator may specify the temperature set point(s) before the run begins, and the PLC sends the information to a PID controller located in the heating unit. The PLC will adjust the set point temperature at specified time intervals according to instructions programmed into the user module. The PLC may not make adjustments to the temperature set point in response to process variations, because this level of control takes place at the heater PID controller, and not at the PLC. It may also communicate a new set point based on startup, shutdown, or emergency shutdown procedures. The temperature sensor installed inside the evaporator vessel may continuously feed a low-voltage, analog electric signal to the PLC. Consequently, the PLC converts the signal into a temperature reading, and displays the temperature on a system readout screen. This temperature probe will indicate to the PLC if the process gets grossly out of bounds, in which case it sends commands to shut down the entire system. For example, if the temperature sensor indicates a system temperature of 30 F above a set point temperature, the PLC may act to shut down the system. In another example, the controller may also act to shut down the system if the system temperature is 30 F below the set point. In both instances, an error message may be transmitted to a display panel alerting the operator about temperature variations beyond set thresholds.

Next, the PLC issues a temperature set point to the chiller/switch cooling unit based on operator input. As an example, if the set point is below 30° C., then the glycol chiller 152 issues a cooling fluid to the condenser. In another example, if the temperature set point is above 30 C, then the cooling fluid may be delivered from the switch 150. The switch may deliver a higher temperature cooling fluid because the switch has a separate fluid loop, and is cooled in turn by the glycol chiller and a heat exchanger in the switch unit. For example, the glycol chiller may produce a cooling fluid in the temperature range of 20-30° C., and passes the fluid through the heat exchanger to absorb heat in the switch fluid loop. The fluid in the switch loop may be maintained in a temperature range of 50-60° C., for example. The programmable logic controller may not issue instructions for adjusting the chiller set point during regular operation due to deviations from system set points. The PLC, however, may issue these adjustments during operation according to preset programs or commands entered through the user module. The PLC may also act to shut down the chiller in the event of the process going out of bounds and the subsequent occurrence of an emergency shut down procedure.

Referring to FIG. 7, a flowchart is shown for an example process 700 used for producing a cannabinoid product using this evaporation and distillation production system. For example, feed material in an evaporator vessel may be heated to vaporize cannabinoids and related constituent compounds which are fractionally separated in a distillation column and passed through a condenser to produce a distillate. Subsequently, the distillate from the condenser is collected in one or more collection tanks where the distillate is further conveyed to different storage vessels operating under atmospheric pressure. Instructions for controlling the system and the rest of the methods included herein may be executed by a programmable logic controller 12 based on instructions stored on a memory of the controller and in conjunction with signals received from system sensors, such as the sensors described above with reference to FIGS. 1-5E. The controller may employ system actuators to adjust operations of various components of the system during and after the production process, according to the methods described below.

At 701, the evaporator vessel may be at rest and ready to be used for production of cannabinoids and related constituent compounds such as terpenes, etc. The temperature of the cooling fluid (e.g., glycol used in the dephlegmator and condenser) has reached its set point, and a thermal fluid heater (such as thermal fluid heater 148 shown in FIG. 1) has reached its set point. Circulation of the heating fluid to the evaporator has not begun yet. In this case, the evaporator vessel is clean, empty and ready to be loaded.

Next at 702, method 700 involves loading feed material comprising a solvent mixture containing valuable compounds into the evaporator vessel. For example, the solvent mixture may be a homogenous mixture of solvent and product compounds with mass ratios in the range of 3:1 and 300:1. In one example, the solvent may be ethanol, isopropanol, hexane, or a similar organic solvent. The operator checks that all ports, manways, sight glasses, and any other leak points are sealed. Subsequently, the solvent mixture is conveyed via a pump to a top port (in the evaporator vessel) through a sanitary stainless steel fitting. For example, the solvent mixture being conveyed by the pump may be a fairly thin liquid, light-amber to dark colored. In one example, the viscosity of the solvent mixture may be greater than water but less than agave syrup. A hose or pipe fitted to the pump may be solvent compatible and comprised of a food grade material. The pump may be turned off, and the port closed, when all the solvent mixture has been conveyed or upon completing a fill cycle to a preset volume. At this point, the operator may check to ensure that all connections to a vacuum pump, thermal fluid heater, thermal fluid cooler, and agitator have been secured.

At 704, method 700 involves removing bulk solvent and other highly volatile compounds (like dissolved gases) from the solvent mixture. The programmable logic controller (PLC) may act to control process variables such as evaporator temperature, pressure, condenser temperature, and agitation speed. The evaporator temperature may be controlled by adjusting temperature of heating jacket and thermal fluid heater disposed between walls of the vessel. The condenser temperature may be regulated adjusting temperature of cooling fluid (e.g., glycol solution) in a chiller (such as chiller 152 shown in FIG. 6). The agitator speed is controlled via an electric motor and variable frequency drive (such as motor 130 and VFD 109 shown in FIG. 1); the electric motor mounted either on a top or bottom portion of the evaporator vessel.

Pressure and temperature sensors, installed on internal walls of the evaporator vessel and connected to the PLC, allow the PLC to read system data and make adjustments to vacuum pressure, coolant temperature, and heating fluid set point to maintain the process at desired set points. For example, the temperature of the evaporator vessel may be increased to a threshold level that allows optimal heating of the solvent mixture. The distillation of the solvent mixture proceeds according to preset values and system logic, allowing the solvent to vaporize from the mixture and flow into the distillation apparatus. Subsequently, the vapor is conveyed via an optional reflux column to the condenser where the vapor undergoes cooling before flowing to one or more collection tanks.

At 706, the distillate from the condenser is collected in the collection tanks. The solvent in the collection tanks is free of cannabinoids and other heavier compounds, and can be re-used in the next extraction process. The collection system operates in a manner that makes it possible to remove solvent during operation of the evaporator vessel. Alternatively, the distillate or solvent may be automatically collected by the collection system during production.

During solvent removal from the collection system, the second collection tank (such as collection tank in collection system 127 shown in FIG. 5A) may be isolated from the first collection vessel tank by closing the ball or check valve. This enables the second collection tank to be re-pressurized up to atmospheric pressure to expedite solvent removal, while the first collection tank (such as collection tank in collection system 126 shown in FIG. 5A) is used to collect solvent during an uninterrupted production and collection process. When the second collection tank reaches atmospheric pressure, the solvent contained within the tank is recovered by opening the ball valve to allow the solvent to drain into a separate storage vessel operating at atmospheric pressure. Alternatively, the solvent recovered from the second collection tank may be conveyed via a pump to a storage vessel. Once the second collection tank is drained, the bottom valve may be closed, and vacuum pressure restored inside the tank. The ball valve separating the first and second collection tank may be re-opened.

At 708, viscous oil enriched in cannabinoids is left in a bottom portion of the evaporator vessel as a byproduct of the extraction process. Specifically, as the solvent/product solution inside the evaporator vessel heats up, its viscosity decreases further. As the heating continues, the solvent which has a lower vaporization temperature than the cannabinoid compounds will begin to evaporate from the mixture. As the solvent vaporizes from the mixture, a raffinate or bottom product in a form of a viscous oil is left at the bottom of the evaporator. The viscous oil, which is dark in color, thickens due to reduction in solvent dilution. The agitator mounted inside the evaporator vessel ensures optimum mixing and heat transfer to allow complete solvent evaporation and minimizes bumping phenomena which may cause contamination between the distillate and raffinate. As an example, the solvent may be considered completely removed from the mixture if the raffinate contains less than 5000 ppm residual solvent. The solvent recovered in the collection system may be of similar quality and purity as the solvent used in the initial dilution process of the feed mixture. Once the solvent has been recovered, the darker raffinate oil may become viscous upon cooling due to increased viscosity. Removal of viscous oil from the evaporator vessel defines an end of a first stage of product extraction from the feed material.

At 710, method 700 involves removing the viscous oil or bottom product from the evaporator. As an example, the evaporator vessel is designed to stay warm to allow easy removal of concentrated viscous oil from the bottom of the vessel. Upon completion of the solvent recovery, the PLC turns off the vacuum pump, chiller, and agitator. The pressure in the evaporator vessel is allowed to return to atmospheric level, and collection of the raffinate proceeds depending on evaporator body is used.

For example, a large volume evaporation apparatus with manway access provided on a side and top portion of the evaporator vessel may be employed for the processing of cannabinoids. The raffinate oil, left in the bottom of the evaporation vessel, may be collected through a port on the bottom of the vessel by opening a ball or check valve and allowing the raffinate to drain into a storage vessel. For example, the valve may be comprised of a food grade and solvent compatible material. This process may proceed while the evaporator vessel is still warm to reduce the viscosity of the raffinate oil. The agitator may be left operating to facilitate the recovery of the cannabinoid oils as long as the manway access is closed. Once most of the oils are recovered, the agitator may be turned off, and the side manway may be opened for operator access. The evaporator vessel may be scrapped with a food grade, solvent compatible spatula to complete the oil recovery process.

In another example, a small evaporator vessel with a tipping frame may be used for oil recovery. In this case, the evaporator vessel may be tipped to one side to allow the raffinate oil to be poured slowly out of the vessel, and the operator may speed up the recovery process by scrapping the oil with a spatula or other suitable item. The blades of the agitator can be easily removed from the evaporator vessel to facilitate cleaning. The hub holding the agitator blades is designed so that the operator can quickly and easily remove them for more thorough cleaning. The oil removal may be conducted while the vessel is still moderately warm to reduce the oil viscosity, allowing for expedient raffinate oil recovery. The raffinate oil containing cannabinoids may become highly viscous and darker in color (compared to the solvent mixture) upon cooling. Alternatively, the viscous oil may be left inside the evaporator vessel and a second stage of cannabinoid product refining is implemented.

Next at 712, de-solvated cannabinoid oil may be added to the raffinate oil left in the evaporator vessel. For example, additional cannabinoid oil may be added through the top manway opening (such as top manway 220 shown in FIG. 2C) in the evaporator vessel. The second stage of product concentration and refining may involve evaporation of compounds with higher boiling points, such as cannabinoids. The operator may check to ensure that all vessel ports, manways, sight glasses, and any other openings are closed. Also, the operator may check to ensure that all connections to the vacuum pump, heating elements, and agitator have been secured.

The production process is initiated by the PLC according to operator selected parameters entered through the user module. The PLC sends signals to control process variables, such as evaporator temperature and pressure, condenser temperature, and agitation speed. System sensors such as pressure and temperature sensors are mounted inside the evaporator vessel and connected to the PLC, which allows the PLC to read system data and make adjustments to vacuum pressure, run duration, and heater and chiller set points. In this mode of operation (cannabinoid distillation), the PLC may make adjustments to heating fluid set point over time and during normal operation, but it may not make adjustments to heater fluid temperature in response to deviations in process fluid temperature. This level of control takes place at the PID associated with the heating unit. The distillation proceeds according to preset values and system logic, such that the terpenes, then the cannabinoids, and then the heavier compounds are volatilized from the mixture and ultimately collected in the collection system.

At 714, method 700 involves evaporating the viscous oil to extract target compounds such as terpenes and cannabinoids. For example, lighter molecular weight compounds may be vaporized earlier from the raffinate oil. The agitator may be kept running to ensure even heat transfer, production of clean and complete product fractions. The bumping phenomena may also be reduced by agitator motion. Cannabinoid compounds such as tetrahydrocannabinol (THC) and cannabidiol (CBD) may be volatilized at temperature ranges of 130-300° C. depending on the level of the vacuum pressure (typically between 0.001 mbar and 2.0 mbar). During production, heavier compounds with higher vaporization temperatures may also be volatilized after the light compounds have been extracted.

Next at 716, the distillate containing terpenes, cannabinoids and other related compounds is collected in distinct fractions using a collection system, most suitably of the variety depicted in FIG. 5C. For example, the collection tanks may be different from the collection vessels used for the solvent recovery. However, components of the collection system are modular, and may be re-combined with vessel components used for solvent recovery for added functionality, allowing multiple fractions of the product to be collected in different collection tanks. For example, the terpenes may be collected in a first collection tank, and the cannabinoids may be collected in a second collection tank. In one example, the collected cannabinoid distillate may be clear, highly-viscous oil, or slightly amber colored oil more viscous than honey. In another example, heavier molecular weight compounds may be collected separately in a third collection tank.

At 718, method 700 may involve processing residual oil in the evaporator vessel to distill secondary products such as essential omega-3 and omega-6 fatty acids, plant waxes, sterols and other compounds commonly used for production of creams, lotions, and dietary supplements. For example, these secondary products may include heavier molecular weight compounds that volatilize at higher vaporization temperatures than the cannabinoid fractions.

At 720, residual or bottom products remaining in the evaporator vessel may be removed. The PLC may act to turn off the vacuum pump, heater and agitator. The PLC may further act to adjust the chiller and the switching mechanism to cool the thermal fluid heater to a temperature of approximately 120° F. The thermal fluid may be circulated continuously to allow for expedient removal of the bottom products. The pressure inside the evaporator vessel may return to atmospheric pressure to allow for expedient removal of the bottom products. The exact procedure followed to remove the raffinate may depend on the configuration and size of the evaporator used in the product refining process.

For example, a large volume evaporator with manway access may be provided for cannabinoid product refining. The raffinate in the bottom of the evaporator vessel may be allowed to flow under gravity or additionally under a pressure gradient through a sanitary fitting located at a bottom portion of the vessel. As an example, the sanitary fitting may be comprised of a food grade material such as stainless steel, and the fitting may be sized with an internal diameter of 2-12 inches. The raffinate removal may be facilitated by a warm temperature inside the vessel which reduces the viscosity of the bottom product. In other examples, the agitator may be turned on to facilitate quick recovery of the raffinate. Once most of the oils are recovered, the agitator may be turned off, and the manway may be opened to allow the operator to scrape any remaining oil from the evaporator walls.

In another example, a small volume evaporator vessel with a tipping hinge may be used in the cannabinoid refining process. The raffinate removal process is slightly different compared to the large evaporator vessel, since a top cover of vessel may be removable, allowing the raffinate to be poured out when the vessel is tilted. Optionally, the agitator blades may be removed to facilitate easy pouring of the raffinate. Also, the vessel may be scraped with a food grade, solvent compatible spatula to speed the recovery process. The raffinate in the bottom portion of the vessel may be comprised of viscous compounds that were not vaporized. Also, the bottom raffinate may contain color pigments present in the feed material, and may result in the raffinate having a darker color than the initial feed material due to product concentration and volume reduction. The ratio of initial feed material to raffinate may vary, depending on quality of the feed material loaded into the evaporator, and the degree of product evaporation desired by the operator.

At 722, the evaporator is cleaned and sterilized after the raffinate has been removed. The evaporator is prepared for a next batch operation for refining cannabinoids and related compounds, and the method exits.

The production process comprises extracting multiple product fractions from feed material in evaporator vessel connected to the distillation column and condenser. The evaporator may be heated, allowing product vapor to flow into the distillation column where the vapor is fractionally separated in distinct product compounds such as terpenes, cannabinoids and other related compounds. Once the volatile products have been recovered, residual bottom product comprising viscous oil may be recovered. In this way, the production process allows for extraction of multiple products from a single feedstock material while improving production efficiency.

Referring to FIG. 8, a schematic depiction of an example graphical output 800 of system parameters used during production of cannabinoids and related compounds. The graphical output 800 demonstrates how the entire production system adjusts process variables during nominal operation. The sequence of FIG. 8 may be provided by executing instructions in the system of FIGS. 1-6 according to the methods of FIG. 7. Vertical markers at times T0-T8 represent times of interest during the sequence. In all the plots discussed below, the horizontal axis represents time and time increases from the left side of each plot to the right side of each plot.

The first plot from top of FIG. 8 depicts residual volume versus time. The vertical axis represents a residual volume of the product and the residual volume increases in the direction of the vertical axis arrow. Trace 802 represents the residual volume.

The second plot from top of FIG. 8 depicts temperature versus time. The vertical axis represents a temperature of a heating medium and the temperature increases in the direction of the vertical axis arrow. Trace 804 represents the temperature of the heating medium and horizontal line 806 represents room temperature.

The third plot from top of FIG. 8 depicts pressure versus time. The vertical axis represents a pressure inside the evaporator vessel and the pressure increases in the direction of the vertical axis arrow. Trace 808 represents the system pressure.

As an example, the evaporator vessel may have a gross volume of 100 L, with a nominal operational capacity of about 70 L. It may be assumed that both solvent and product oil are evaporated in a single batch. No precise time values are given in the graphical output, since process duration is highly dependent upon a type of solvent that is being evaporated.

At T0, the evaporator vessel is empty as depicted by trace 802 showing vessel volume. The heating fluid temperature (804) and pressure (808) inside the evaporator may be at ambient levels. For example, the heating fluid temperature may be equal to the room temperature (806).

Between T0 and T1, an operator may load the evaporator vessel with feed materials as disclosed with reference to FIGS. 2A-2C. Subsequently, the volume of the evaporator vessel increases as the operator continues filling the vessel until the nominal capacity of 70 L is reached. The temperature and pressure of the system remain at steady values. For example, the ambient pressure of the system may be equal to atmospheric pressure. During this period, the operator may first seal the evaporator before turning on the system. The system may take a few minutes to reach operating temperature and pressure, before any evaporation processes commence.

Between T1 and T2, the pressure may be steadily decreased until a desired set point is reached. As an example, the set point may be selected as 80 mbar. The heating fluid temperature may be steadily increased until a desired circulating fluid set point is attained. The agitator may be turned on to enhance heat transfer across the feed material, and minimize occurrence of bumping. The volume of the feed material does not change since the evaporation process does not begin until the system reaches its ideal set points.

At T2, the system has reached its operational temperature and pressure, and the solvent may begin to boil. The agitator is operating at a preset speed, and the system is operating at set operating parameters. Solvent may begin evaporating and condensing in the condenser before flowing to a collection system.

Between T2 and T3, the solvent may be removed in bulk quantities. The temperature of the heating medium and pressure inside the evaporator may be maintained at the set operational levels. As a result, the evaporation rate is maintained at a relatively constant rate until the solvent is nearly depleted. The volume of the solvent mixture in the vessel is reduced from the initial 70 L to a relatively small volume of concentrated, de-solvated product oil. For example, the volume of the solvent mixture may decrease from the initial volume of 70 L to a final volume of 15 L, where the final volume is a viscous oil containing cannabinoids and related compounds.

At T3, the solvent removal stage of operation is stopped. As an example, the PLC may provide a preset command (defined by the operator) directing the system to stop solvent distillation. In another example, the operator may manually enter a command using a user defined module to stop the solvent distillation process. Subsequently, an atmospheric vent on the vacuum control system may be opened to reset the pressure level in the evaporator to atmospheric pressure. The heating fluid temperature may be adjusted to a different operator-chosen set point. For example, the heating fluid temperature may be set to a temperature range of 90 to 120° F., allowing the evaporator to be safely handled by the operator. The cooling fluid may stop circulating through the condenser and the evaporator is ready for the operator to either remove the de-solvated oil, add more oil, or give a command directing the evaporator to distill cannabinoids and related compounds.

Between T3 and T4, the temperature of the evaporator body decreases to a lower value that is safer for handling, and the pressure inside the evaporator vessel increases to a level equal to atmospheric pressure. The volume of the mixture in the vessel remains fairly constant in this example, as it is assumed that the operator does not add any additional cannabinoid oil.

Between T4 and T5, the volume of the mixture in the evaporator, the temperature of the heating fluid and pressure inside the vessel are maintained at steady values. There may be a short duration (e.g., a few minutes) during which the evaporator operating parameters may be in a stage between operational and resting set points. Thus, a short time interval is provided to allow the system to reach adjusted set points. When the system reaches the resting set point conditions, the operator may access the evaporator. Subsequently, the operator may clean, load, or unload the evaporator vessel. These operations may be conducted in a short or long time period, depending on operator needs and user set commands.

At T5, the operator may adjust evaporator vessel to proceed with the distillation of cannabinoids and related compounds from the residual mixture in the vessel. The adjusting may include setting system operation parameters such as pressure, heating fluid and coolant temperature, to new values. As an example, the PLC may act to adjust evaporator pressure and heating fluid temperature to operational set points suitable for cannabinoid distillation from the residual viscous oil in the vessel.

Between T5 and T6, the heating fluid temperature may increase while the pressure inside the evaporator may decrease until the set points are reached. Once, the set points are reached, the viscous oil may begin to boil, and cannabinoids and related compounds may be vaporized from the oil.

Between T6 and T7, the volume of the viscous oil in the vessel may decrease as cannabinoids and related compounds are vaporized from the oil. The temperature may increase gradually while the pressure decreases gradually as well. For example, the temperature of the heating fluid may increase linearly. In another example, the temperature may be increased in discrete steps defined by the operator. In one example, the temperature may begin rising from approximately 130 C (e.g., vaporizing temperature of terpene compounds), and increases until it reaches a maximum of approximately 300° C. (vaporizing temperature of heavier related compounds and oils). The operating pressure may slowly decrease, within a pressure range of 0.001 mbar to 2.0 mbar. In other examples, the operating pressure may remain constant at a value between 0.001 mbar and 5 mbar. The evaporation rate may not be constant during this stage, since the mixture components in the evaporator may be increasingly non-volatile.

At T7, the vaporization of cannabinoids from the viscous oil is stopped, and the system may be directed to return to resting parameters similar or identical to those parameters at T3.

Between T7 and T8, the temperature of the heating fluid is decreased rapidly and the evaporator pressure is increased to atmospheric pressure. As a result, the evaporator temperature may decrease gradually. For example, the evaporator vessel temperature may decrease to a temperature within a range of 90-120° F., allowing the operator to remove residual oil or bottom product from the vessel safely.

After T8, the temperature and pressure may be maintained at steady adjusted values. The operator may remove residual oil or bottom product from the evaporator vessel. After the residual oil has been removed, the evaporator may be cleaned and reloaded to perform another batch operation. In this way, the production process may allow concentration and refining of cannabinoid and related compounds from a single feedstock material while improving process efficiency.

FIG. 9 is a schematic depiction of an example graphical output 900 of the PLC automatically adjusting system parameters during production of cannabinoids in response to deviations from ideal process set points. The graphical output 900 demonstrates corrections to system pressure and cooling/heating fluid temperatures during the concentration and refining process of cannabinoids. For example, pressure changes from atmospheric pressure towards its target operating pressure are disclosed. The sequence of FIG. 9 may be provided by executing instructions in the system of FIGS. 1-6 according to the methods of FIG. 7. Vertical markers at times T0-T6 represent times of interest during the sequence. In all the plots discussed below, the horizontal axis represents time and time increases from the left side of each plot to the right side of each plot.

The first plot from top of FIG. 9 depicts system pressure versus time. The vertical axis represents a system pressure inside the evaporator vessel and the system pressure increases in the direction of the vertical axis arrow. Trace 902 represents the system pressure, and horizontal line 904 represents a target pressure level.

At T1, the system may be operating at a pressure level (902) of 1.0 atmospheres (e.g., equivalent to 1000 mbar). The vacuum pump may be set to operate at full capacity until it reaches a critical point defined by an operator as a threshold set point of approximately 10-100 mbar above the pressure set level 904.

Between T0 and T1, the system pressure may decrease very rapidly but remains above the pressure set point. As an example, an evaporator may decrease in pressure rapidly and reach the set point in less than 15 minutes. At T1, the pump may reach the critical point, and thus may be adjusted to decrease its pumping speed as it approaches the set point. The pump capacity may decrease as the vacuum level increases. The vacuum level may play a role in slowing down the pump speed as the pump approaches the pressure set point.

Between T1 and T2, the pressure may decrease gradually, and the pump may continually slow the pump rate to avoid undershooting the pressure set point. At T2, the pump has overshot the set point, and as result the system pressure may decrease below an ideal set point. This overshooting seldom occurs, and may indicate that the system may not be very well tuned. The evaporator vessel has a mechanism to mitigate vacuum overshot. For example, an atmospheric vent on the evaporator vessel may be opened to allow entry of air into the vessel, allowing the system pressure to increase. In this example, the system reached its open-threshold, described in previous section.

Between T2 and T3, the pressure may increase rapidly, and overshoot the pressure set level again. At T3, the previous vent opening at T2 may have lasted too long, and now the system is over its set point. This may seldomly happen, as the system attains a seal-threshold at a pressure level lower than the set point but above the open-threshold, which stops the pressure from increasing inside the evaporator. In this example, the set point has been overshot again. The pump is operating, but at a lower capacity due to a small difference between the pressure set level and the current pump pressure. The pump may be operated at a slow rate in order to attain the pressure set level.

Between T3 and T4, the system pressure decreases gradually until it reaches the pressure set level. At T4, the pressure in the evaporator reaches the pressure set point, and the pump is turned off. The pump may remain turned off until the system pressure increases again, and the evaporator vessel or process unit is re-evacuated. This increase in pressure may be caused by vaporization of feed material or by a leak in the system that permits external air to slowly enter the process unit.

Between T4 and T5, the system pressure may remain fairly steady. After T5, the system pressure may increase beyond the pressure set level. For example, the process unit may develop a leak or more feed material may be evaporated than the condenser can handle, causing an increase in pressure. The pump may be adjusted to operate at a fraction of its total capacity, to allow the system to adjust to optimal operational parameters. At T6, the vacuum pump may be turned off until needed. In this way, the system pressure may be controlled by varying the pump operating parameters and selecting a desired pressure set point that allows the process unit to operate efficiently.

The second plot from top of FIG. 9 depicts heating fluid temperature versus time. The vertical axis represents a temperature correction of the heating fluid, and the heating fluid temperature increases in the direction of the vertical axis arrow. Trace 906 represents the heating fluid temperature, and horizontal line 908 represents a target temperature level.

At T0, thermal fluid may be circulating at room temperature. The thermal fluid heater may receive a temperature set point signal from the PLC to raise the temperature of the circulation fluid. As a result the temperature of the heating fluid may increase rapidly between T0 and T1, but remains below the temperature set level. For example, the heating element may be operated at maximal capacity until a threshold temperature is attained.

At T1, the fluid temperature may be close to the temperature set level. Subsequently, a proportional integral derivative (PID) controller attached to the heater may lower power output of the heating element. A rate of falloff of the heater power output may be controlled by operator defined commands stored in the PID controller. For example, the heater output falloff rate may be process dependent and may be set by the operator.

Between T1 and T2, the heating fluid temperature may increase further. At T2, the heating fluid temperature has reached closer to the temperature set level, and the PID controller may be further adjusted to lower the heater output power, in an attempt not to overshoot the temperature set level.

Between T2 and T3, the heating fluid temperature may increase further, until it reaches the temperature set level. At T3, the system is operating at the temperature set level, and the PID controller again may lower heater output in order to prevent the process from overshooting the temperature set point. The PID may instruct the heater to supply a threshold power to maintain the heating fluid at the temperature set level.

Between T3 and T4, the heating fluid temperature may decrease slowly since the heater is provided with less energy than needed to maintain the temperature set level. At T4, heating fluid temperature reaches a level slightly below the temperature set point. The PID controller may automatically increase the heater power input in order to increase the heating fluid temperature.

Between T4 and T5, the heating fluid temperature increases gradually until it again reaches the temperature set point. At T5, the heating fluid temperature reaches the temperature set point, and the PID may automatically decrease power input to maintain the set point temperature. In this case, the process becomes stable as the PID controller establishes and maintains a new stable heater power level. The PID controller may also automatically compensate for decreased power load during operation.

After T6, the heating fluid temperature is maintained at the temperature set level. In this way, heating fluid temperature in the evaporator vessel may be controlled by varying power supplied by the thermal heater and selecting a desired temperature set level that allows the vessel to be heated efficiently.

The third plot from top of FIG. 9 depicts a cooling fluid temperature versus time. The vertical axis represents the cooling fluid temperature and the cooling fluid temperature correction increases in the direction of the vertical axis arrow. Trace 910 represents the cooling fluid temperature, and horizontal line 912 represents a target cooling fluid temperature.

The cooling fluid temperature (910) may be controlled in the same or a similar manner as the heating fluid temperature. The PLC feeds a cooling temperature set point into the PID controller for a chiller unit. Subsequently, the controller may be adjusted to operate the chiller within user defined threshold levels. The PID controller may be further adjusted to meet other process or system requirements.

At T0, the cooling fluid is set at ambient temperature (910). Upon receiving the cooling fluid temperature set point, the system may turn on, and begin chilling the cooling fluid to the desired temperature. A rate of cooling may be initially quick, because the PID controller may be operating the chiller at full capacity. Between T0 and T1, the cooling fluid temperature quickly decreases but remains above the set cooling fluid temperature level (912).

Between T1 and T2, the cooling fluid temperature decreases but a rate lower than the initial decrease observed between T0 and T1. The chiller begins cycling stages on and off to reduce chiller cooling capacity. The PID controller may gradually lower the chiller cooling capacity in order to meet, but not overshoot the temperature set point. For example, the controls on the chiller may be identical to controls attached to the thermal heater. A significant difference between the heater and chiller, is compressors on the chiller are usually cycled on/off, and do not usually have intermediate power demand settings.

Between T2 and T3, the cooling fluid temperature gradually decreases until the cooling fluid temperature reaches the fluid temperature set level. The cooling fluid temperature may remain at the fluid temperature set level until T4.

Between T4 and T5, the cooling fluid temperature gradually increases and overshoots the desired temperature set point. In this case, the chiller may have failed to meet the required cooling capacity, and thus the PID controller may operate chiller with at least one cooling stage engaged to lower the cooling fluid temperature again.

Between T5 and T6, the cooling fluid temperature gradually decreases until it reaches the fluid temperature set level. At T6, the cooling fluid is at the temperature set level. Optionally, the cooling fluid may be subcooled slightly below the temperature set level to disengage all chiller stages. Once the temperature set level is reached, the PID controller may engage a single chiller stage to meet cooling demand. If the cooling demand is not met, then an additional chiller stage may be engaged. The temperature may drop and the chiller may be cycled off. The cycle may be continued depending on operational needs.

In this way, the cooling fluid temperature in the system may be controlled by varying the chiller cooling capacity, and selecting a desired fluid temperature set level that allows the system to be cooled efficiently.

In one example, a production system comprises: an evaporator connected to a distillation apparatus and condenser column. In the preceding example additionally or optionally, the evaporator includes an agitator that is mounted through a bottom portion of the evaporator, the agitator driven by an electric motor that is coupled to a gearbox and a variable frequency drive. In any or all of the preceding examples, additionally or optionally, the agitator comprises blades that are mounted in an interior bottom region of the evaporator. In any or all of the preceding examples, additionally or optionally, the evaporator includes a top removable cover coupled tightly to a top portion of a vertical cylindrical section of the evaporator, the removable cover having an opening arm which extends vertically downward. In any or all of the preceding examples, additionally or optionally, the evaporator includes an agitator that is mounted through a top portion of the evaporator, the agitator driven by an electric motor that is coupled to a gearbox and a variable frequency drive.

Furthermore, in any or all of the preceding examples, additionally or optionally, the agitator comprises blades having vertical extending arms that project up into an interior region of the evaporator. In any or all of the preceding examples, additionally or optionally, the evaporator includes a first manway formed on a top removable cover of the evaporator, and a second manway formed in a cylindrical vertical portion of the evaporator. In any or all of the preceding examples, additionally or optionally, the distillation unit includes a dephlegmator unit that is mounted above a transition annular pipe and a vertical distillation column. In any or all of the preceding examples, additionally or optionally, the dephlegmator unit comprises a plurality of cylindrical tubes mounted inside a shell opening of the dephlegmator. In any or all of the preceding examples, additionally or optionally, the vertical distillation column includes a perforated sieve tray or fine material packing.

In other preceding examples, additionally or optionally, the distillation unit includes a dephlegmator unit that is mounted between an L-shaped transition annular pipe and a vertical distillation column. In any or all of the preceding examples, additionally or optionally, the dephlegmator unit comprises one or more cylindrical tubes mounted inside a shell opening of the dephlegmator. In any or all of the preceding examples, additionally or optionally, the vertical distillation column is packed with structured packaging materials. In any or all of the preceding examples, additionally or optionally, the condenser column comprises one or more cylindrical tubes mounted inside a shell opening of the condenser.

An example method comprises: processing cannabis and/or hemp to yield viscous oils enriched in cannabinoids with an evaporator/distiller, including, with the evaporator/distiller removing ethanol or other organic solvents via distillation from a mixture of both solvent and viscous compounds comprising cannabinoids, and subsequently distilling the cannabinoids at a reduced pressure and temperature from the viscous oils. In any or all of the preceding examples, additionally or optionally, the evaporator/distiller includes an evaporator vessel connected to a distillation column having a dephlegmator unit. In any or all of the preceding examples, additionally or optionally, the column is connected to a condenser via a tube. In any or all of the preceding examples, additionally or optionally, during operation, a product is vaporized from feed material inside the evaporator vessel and flowed through the distillation column, and where the product vapor is fractionally separated into different product compounds.

Any or all of the preceding examples, may additionally or optionally further comprise, subsequent to the fractional separation, the product compounds are flowed from the distillation column to the condenser unit, where the compounds are cooled before being conveyed to a collection system. The preceding example method, may additionally or optionally comprise, de-solvating cannabinoid rich oils, and/or performing subsequent distillation of the cannabinoids themselves, with an evaporation unit.

Note that the example control and estimation routines included herein can be used with various evaporation, distillation and collect system configurations. The control methods and routines disclosed herein may be stored as executable instructions in non-transitory memory and may be carried out by the control system including the controller in combination with the various sensors, actuators, and other system hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the process control system, where the described actions are carried out by executing the instructions in a system including the various system hardware components in combination with the electronic controller.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A production system comprising:
an evaporator connected to a distillation unit and condenser column.

2. The production system of claim 1, wherein the evaporator includes an agitator that is mounted through a bottom portion of the evaporator, the agitator driven by an electric motor that is coupled to a gearbox and a variable frequency drive.

3. The production system of claim 2, wherein the agitator comprises blades that are mounted in an interior bottom portion of the evaporator.

4. The production system of claim 2, wherein the evaporator includes a top removable cover coupled tightly to a top portion of a vertical cylindrical section of the evaporator, the removable cover having an opening arm which extends vertically downward.

5. The production system of claim 1, wherein the evaporator includes an agitator that is mounted through a top portion of the evaporator, the agitator driven by an electric motor that is coupled to a gearbox and a variable frequency drive.

6. The production system of claim 5, wherein the agitator comprises blades having vertical extending arms that project up into an interior region of the evaporator.

7. The production system of claim 5, wherein the evaporator includes a first manway formed on a top removable cover of the evaporator, and a second manway formed in a vertical cylindrical portion of the evaporator.

8. The production system of claim 1, wherein the distillation unit includes a dephlegmator unit that is mounted above a transition annular pipe and a vertical distillation column.

9. The production system of claim 8, wherein the dephlegmator unit comprises a plurality of cylindrical tubes mounted inside a shell opening of the dephlegmator.

10. The production system of claim 8, wherein the vertical distillation column includes a perforated sieve tray.

11. The production system of claim 1, wherein the distillation unit includes a dephlegmator unit that is mounted between an L-shaped transition annular pipe and a vertical distillation column.

12. The production system of claim 11, wherein the dephlegmator unit comprises one or more cylindrical tubes mounted inside a shell opening of the dephlegmator.

13. The production system of claim 11, wherein the vertical distillation column is packed with structured packaging materials.

14. The production system of claim 1, wherein the condenser column comprises one or more cylindrical tubes mounted inside a shell opening of the condenser.

15. A method comprising:
processing cannabis and/or hemp to yield viscous oils enriched in cannabinoids with an evaporator/distiller, including, with the evaporator/distiller removing ethanol or other organic solvents via distillation from a mixture of both solvent and viscous compounds comprising cannabinoids, and subsequently distilling the cannabinoids at a reduced pressure and temperature from the viscous oils.

16. The method of claim 15, wherein the evaporator/distiller includes an evaporator vessel connected to a distillation column having a dephlegmator unit.

17. The method of claim 16, wherein the column is connected to a condenser via a tube.

18. The method of claim 17, wherein during operation, a product is vaporized from feed material inside the evaporator vessel and flowed through the distillation column, and where the product vapor is fractionally separated into different product compounds.

19. The method of claim 18, further comprising, subsequent to the fractional separation, the product compounds are flowed from the distillation column to the condenser unit, where the compounds are cooled before being conveyed to a collection system.

20. A method comprising: de-solvating cannabinoid rich oils, and/or performing subsequent distillation of the cannabinoids themselves, with an evaporation unit.
